(19) United States
(12) Patent Application Publication
(10) Pub. No.: US 2017/0109292 A1
(43) Pub. Date: Apr. 20, 2017

(54) MEMORY SYSTEM AND OPERATING METHOD OF THE MEMORY SYSTEM

(71) Applicant: SK hynix Inc., Gyeonggi-do (KR)

(72) Inventors: Jong-Min LEE, Gyeonggi-do (KR); Jee-Yul KIM, Gyeonggi-do (KR)

(21) Appl. No.: 15/061,738

(22) Filed: Mar. 4, 2016

(30) Foreign Application Priority Data
Oct. 15, 2015 (KR) 10-2015-0143852

(51) Int. Cl. G06F 12/10

(52) U.S. Cl. CPC G06F 12/1009; G06F 2212/65

(57) ABSTRACT

In a memory system including a memory device including a plurality of storage regions, and a controller suitable for selecting storage regions indicated by logical addresses from among the plurality of storage regions using a mapping table storing a plurality of pieces of mapping information for mapping a plurality of logical addresses to a plurality of physical addresses corresponding to the plurality of storage regions. The controller may narrow a search range in which a second requested logical address of N logical addresses (N is an integer greater than 2) is to be searched for in the mapping table based on a position in which the mapping information corresponding to a first requested logical address of the N logical addresses has been stored in the mapping table when the N logical addresses are sequentially searched for in the mapping table.

### CROSS-REFERENCE TO RELATED APPLICATION

This application claims priority under 35 U.S.C. §119 to Korean Patent Application No. 10-2015-0143852, filed on Oct. 15, 2015 In the Korean Intellectual Property Office, the disclosure of which is incorporated herein by reference in its entirety.

### BACKGROUND

1. Field

Exemplary embodiments of the present invention relate generally to a semiconductor design technology and, more particularly, to a memory system supporting an address mapping operation and an operating method of the memory system.

2. Description of the Related Art

The computer environment paradigm has shifted to ubiquitous computing systems that can be used anywhere and at any time resulting in a rapidly increasing use of portable electronic devices such as mobile phones, digital cameras, and notebook computers. These portable electronic devices may use a memory system having a memory device for storing data, that is, a data storage device. A data storage device may be used as a main or an auxiliary memory device of a portable electronic device.

Data storage devices using semiconductor memory devices provide excellent stability, durability, high information access speed, and low power consumption since they have no moving parts. Examples of data storage devices having such advantages include universal serial bus (USB) memory devices, memory cards having various interfaces, and solid state drives (SSD).

### SUMMARY

Various embodiments are directed to a memory system capable of searching an address mapping table for a plurality of logical addresses, sequentially requested by a host, more effectively and rapidly and an operating method of the memory system.

In an embodiment, in a memory system including a memory device including a plurality of storage regions, and a controller suitable for selecting storage regions indicated by logical addresses from among the plurality of storage regions using a mapping table storing a plurality of pieces of mapping information for mapping a plurality of logical addresses to a plurality of physical addresses corresponding to the plurality of storage regions. The controller may narrow a search range in which a second requested logical address of N logical addresses (N is an integer greater than 2) is to be searched for in the mapping table based on a position in which the mapping information corresponding to a first requested logical address of the N logical addresses has been stored in the mapping table when the N logical addresses are sequentially searched for in the mapping table.

The controller may be suitable for aligning positions in which the plurality of pieces of mapping information is stored in the mapping table based on the magnitude or sizes of the respective values of the logical addresses corresponding to the plurality of pieces of mapping information, and aligning a sequence in which the requested N logical addresses are searched for in the mapping table based on magnitude or sizes of values of the respective N logical addresses.

If the plurality of pieces of mapping information is aligned so that the plurality of pieces of mapping information is stored in relatively lower positions in the mapping table when magnitude or sizes of values respectively corresponding to the plurality of pieces of mapping information have relatively smaller values, and the N logical addresses are aligned so that the N logical addresses are searched for in the mapping table relatively earlier when the N logical addresses have relatively smaller values, the controller may be suitable for searching only pieces of mapping information stored in positions higher than the position in which the mapping information corresponding to the first requested logical address has been stored in the mapping table for the second requested logical address of the N logical addresses.

If the plurality of pieces of mapping information is aligned so that the plurality of pieces of mapping information is stored in relatively lower positions in the mapping table when magnitude or sizes of values respectively corresponding to the plurality of pieces of mapping information have relatively smaller values and the N logical addresses are aligned so that the N logical addresses are searched for in the mapping table relatively earlier when the N logical addresses have relatively greater values, the controller may be suitable for searching only pieces of mapping information stored in positions lower than the position in which the mapping information corresponding to the first requested logical address has been stored in the mapping table for the second requested logical address of the N logical addresses.

If the plurality of pieces of mapping information is aligned so that the plurality of pieces of mapping information is stored in relatively lower positions in the mapping table when magnitude or sizes of values respectively corresponding to the plurality of pieces of mapping information have relatively greater values and the N logical addresses are aligned so that the N logical addresses are searched for in the mapping table relatively earlier when the N logical addresses have relatively smaller values, the controller may be suitable for searching only pieces of mapping information stored in positions lower than the position in which the mapping information corresponding to the first requested logical address has been stored in the mapping table for the second requested logical address of the N logical addresses.

If the plurality of pieces of mapping information is aligned so that the plurality of pieces of mapping information is stored in relatively lower positions in the mapping table when magnitude or sizes of values respectively corresponding to the plurality of pieces of mapping information have relatively greater values and the N logical addresses are aligned so that the N logical addresses are searched for in the mapping table relatively earlier when the N logical addresses have relatively greater values, the controller may be suitable for searching only pieces of mapping information stored in positions higher than the position in which the mapping information corresponding to the first requested logical address has been stored in the mapping table for the second requested logical address of the N logical addresses.

If the first requested logical address value and second requested logical address value of the N logical addresses have a difference equal to or less than a predetermined value, the controller may be suitable for searching the mapping table for the first requested logical address using a binary search method and searching the mapping table for the second requested logical address using a linear search method.

If the first requested logical address value and second requested logical address value of the N logical addresses have a difference equal to or greater than a predetermined value, the controller may be suitable for searching the mapping table for the first requested logical address using a binary search method and searching the mapping table for the second requested logical address using a binary search method.

The controller may be suitable for storing the plurality of pieces of mapping information in the memory device, selecting pieces of M mapping information (M is an integer greater than N) among the plurality of pieces of mapping information, loading the pieces of M mapping information onto a temporary storage space, aligning positions in which the pieces of loaded mapping information are stored in the temporary storage space based on magnitude or sizes of values of logical addresses respectively corresponding to the pieces of loaded mapping information, and aligning sequence in which the N logical addresses are searched for in the pieces of loaded mapping information based on the magnitude or sizes of the values of the N logical addresses.

The memory device may include a plurality of blocks respectively comprising a plurality of pages, and the plurality of storage regions may respectively corresponds to the plurality of blocks.

The memory device may include a plurality of blocks respectively comprising a plurality of pages, and the plurality of storage regions may respectively corresponds to the plurality of pages.

In an embodiment, an operating method of a memory system comprising a memory device including a plurality of storage regions, for selecting storage regions indicated by logical addresses from among the plurality of storage regions using a mapping table in which a plurality of pieces of mapping information for mapping a plurality of logical addresses to a plurality of physical addresses corresponding to the plurality of storage regions has been stored, the operating method may include a first search step of searching the mapping table for a first requested logical address of N logical addresses (N is an integer greater than 2), and a second search step of controlling a search range based on a position in which the mapping information retrieved through the first search step has been stored in the mapping table and searching for a second requested logical address of the N logical addresses.

The operating method may further include a position alignment step of aligning positions in which the plurality of pieces of mapping information is stored in the mapping table based on magnitude or sizes of values of the logical addresses respectively corresponding to the plurality of pieces of mapping information prior to the first search step, and a sequence alignment step of aligning sequence in which the N logical addresses are searched for in the mapping table based on magnitude or sizes of values of the respective N logical addresses prior to the first search step.

The position alignment step may include a first position determination step of aligning the positions in which the plurality of pieces of mapping information is stored in the mapping table so that the plurality of pieces of mapping information is stored in relatively lower positions in the mapping table when magnitude or sizes of values respectively corresponding to the plurality of pieces of mapping information have relatively smaller values, and a second position determination step of aligning the positions in which the plurality of pieces of mapping information is stored in the mapping table so that the plurality of pieces of mapping information is stored in relatively higher positions in the mapping table when magnitude or sizes of values respectively corresponding to the plurality of pieces of mapping information have relatively smaller values.

The sequence alignment step may include a first sequence determination step of aligning the sequence in which the N logical addresses are searched for in the mapping table so that the N logical addresses are searched for in the mapping table relatively earlier when the values of the respective N logical addresses have relatively smaller values, and a second sequence determination step of aligning the sequence in which the N logical addresses are searched for in the mapping table so that the N logical addresses are searched for in the mapping table relatively earlier when the values of the respective N logical addresses have relatively greater values.

After the first position determination step and the first sequence determination step are performed, the second search step may include searching only pieces of mapping information stored in positions higher than a position in which the mapping information retrieved through the first search step has been stored in the mapping table for the second requested logical address of the N logical addresses, after the first position determination step and the first sequence determination step are performed, the second search step may include searching only pieces of mapping information stored in positions lower than a position in which the mapping information retrieved through the first search step has been stored in the mapping table for the second requested logical address of the N logical addresses, after the second position determination step and the first sequence determination step are performed, the second search step may include searching only pieces of mapping information stored in positions lower than a position in which the mapping information retrieved through the first search step has been stored in the mapping table for the second requested logical address of the N logical addresses, and after the second position determination step and the first sequence determination step are performed, the second search step may include searching only pieces of mapping information stored in positions higher than a position in which the mapping information retrieved through the first search step has been stored in the mapping table for the second requested logical address of the N logical addresses.

The operation method may further include a step of using a binary search method in the first search step and using a linear search method in the second search step if the first requested logical address value and second requested logical address value of the N logical addresses have a difference with a predetermined value or less.

The operation method may further include a step of using a binary search method in the first search step and using a binary search method in the second search step if the first requested logical address value and second requested logical address value of the N logical addresses have a difference with a predetermined value or more.

The position alignment step may include storing the plurality of pieces of mapping information in the memory device, selecting pieces of M mapping information (M is an integer greater than N) among the plurality of pieces of mapping information, and loading the pieces of M mapping information onto a temporary storage space, and aligning positions in which the pieces of loaded mapping information are stored in the temporary storage space based on magnitude or sizes of values of logical address respectively corresponding to the pieces of loaded mapping information.

The sequence alignment step may include aligning sequence in which the N logical addresses are searched for in the pieces of loaded mapping information based on the magnitude or sizes of the values of the respective N logical addresses.

### BRIEF DESCRIPTION OF THE DRAWINGS

FIG. 1 is a diagram illustrating a data processing system including a memory system, according to an embodiment of the present invention.

FIG. 2 is a diagram illustrating a memory device including a plurality of memory blocks, according to an embodiment of the present invention.

FIG. 3 is a circuit diagram illustrating a memory block of a memory device, according to an embodiment of the present invention.

FIGS. 4, 5, 6, 7, 8, 9, 10, and 11 are diagrams schematically illustrating a memory device, according to various embodiments of the present invention.

FIGS. 12A to 12F are diagrams illustrating operations of searching a mapping table for logical addresses requested by a host in a memory system, according to embodiments of the present invention.

### DETAILED DESCRIPTION

Various embodiments will be described below in more detail with reference to the accompanying drawings. The present invention may, however, be embodied in different forms and should not be construed as being limited to the embodiments set forth herein. Rather, these embodiments are provided so that this disclosure will be thorough and complete, and will fully convey the present invention to those skilled in the relevant art. Throughout the disclosure, like reference numerals refer to like parts throughout the various figures and embodiments of the present invention.

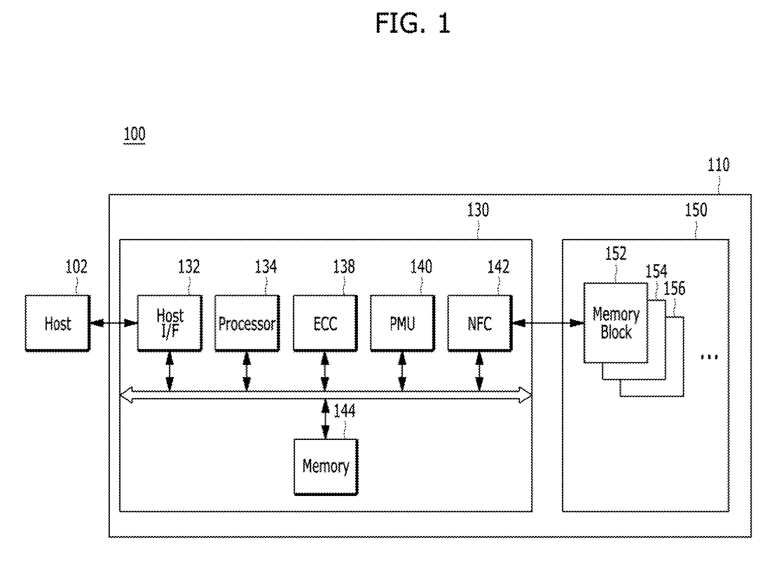

FIG. 1 is a block diagram illustrating a data processing system including a memory system according to an embodiment.

Referring to FIG. 1, a data processing system 100 may include a host 102 and a memory system 110.

The host 102 may include, for example, a portable electronic device such as a mobile phone, an MP3 player and a laptop computer or an electronic device such as a desktop computer, a game player, a TV and a projector.

The memory system 110 may operate in response to a request from the host 102, and in particular, store data to be accessed by the host 102. In other words, the memory system 110 may be used as a main memory system or an auxiliary memory system of the host 102. The memory system 110 may be implemented with any one of various kinds of storage devices, according to the protocol of a host interface to be electrically coupled with the host 102. The memory system 110 may be implemented with any one of various kinds of storage devices such as a solid state drive (SSD), a multimedia card (MMC), an embedded MMC (eMMC), a reduced magnitude or size MMC (RS-MMC) and a micro-MMC, a secure digital (SD) card, a mini-SD and a micro-SD, a universal serial bus (USB) storage device, a universal flash storage (UFS) device, a compact flash (CF) card, a smart media (SM) card, a memory stick, and so forth.

The storage devices for the memory system 110 may be implemented with a volatile memory device such as a dynamic random access memory (DRAM) and a static random access memory (SRAM) or a nonvolatile memory device such as a read only memory (ROM), a mask ROM (MROM), a programmable ROM (PROM), an erasable programmable ROM (EPROM), an electrically erasable programmable ROM (EEPROM), a ferroelectric random access memory (FRAM), a phase change RAM (PRAM), a magnetoresistive RAM (MRAM) and a resistive RAM (RRAM).

The memory system 110 may include a memory device 150 which stores data to be accessed by the host 102, and a controller 130 which may control storage of data in the memory device 150.

The controller 130 and the memory device 150 may be integrated into one semiconductor device. For instance, the controller 130 and the memory device 150 may be integrated into one semiconductor device and configure a solid state drive (SSD). When the memory system 110 is used as the SSD, the operation speed of the host 102 that is electrically coupled with the memory system 110 may be significantly increased.

The controller 130 and the memory device 150 may be integrated into one semiconductor device and configure a memory card. The controller 130 and the memory card 150 may be integrated into one semiconductor device and configure a memory card such as a Personal Computer Memory Card International Association (PCMCIA) card, a compact flash (CF) card, a smart media (SM) card (SMC), a memory stick, a multimedia card (MMC), an RS-MMC and a micro-MMC, a secure digital (SD) card, a mini-SD, a micro-SD and an SDHC, and a universal flash storage (UFS) device.

For another instance, the memory system 110 may configure a computer, an ultra-mobile PC (UMPC), a workstation, a net-book, a personal digital assistant (PDA), a portable computer, a web tablet, a tablet computer, a wireless phone, a mobile phone, a smart phone, an e-book, a portable multimedia player (PMP), a portable game player, a navigation device, a black box, a digital camera, a digital multimedia broadcasting (DMB) player, a three-dimensional (3D) television, a smart television, a digital audio recorder, a digital audio player, a digital picture recorder, a digital picture player, a digital video recorder, a digital video player, a storage configuring a data center, a device capable of transmitting and receiving information under a wireless environment, one of various electronic devices configuring a home network, one of various electronic devices configuring a computer network, one of various electronic devices configuring a telematics network, an RFID device, or one of various component elements configuring a computing system.

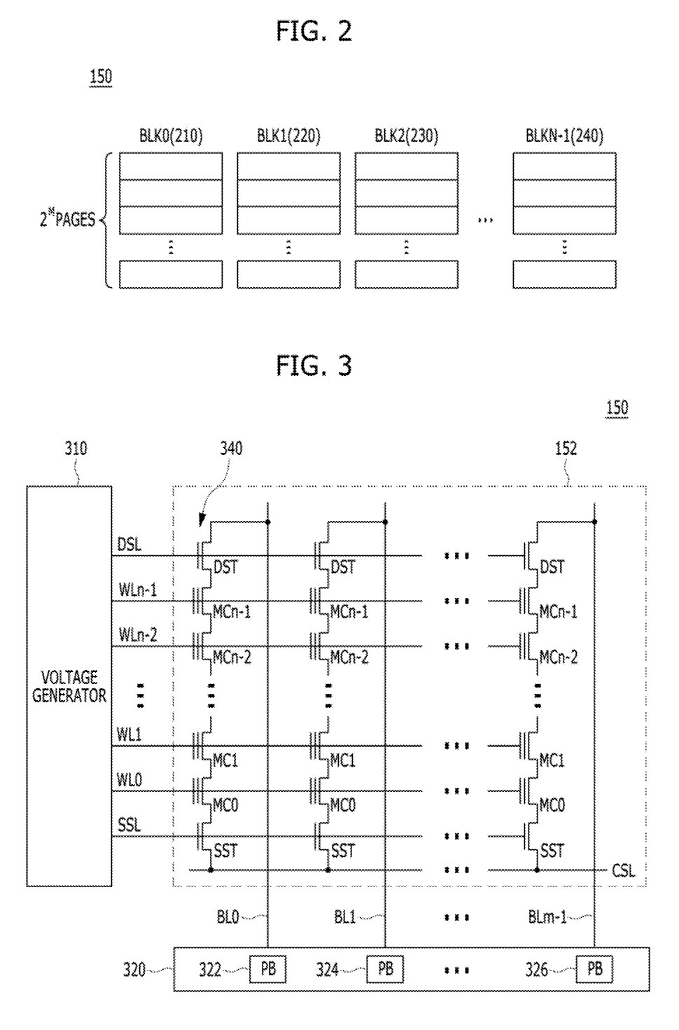

The memory device 150 of the memory system 110 may retain stored data when power supply is interrupted and, in particular, store the data provided from the host 102 during a write operation, and provide stored data to the host 102 during a read operation. The memory device 150 may include a plurality of memory blocks 152, 154 and 156. Each of the memory blocks 152, 154 and 156 may include a plurality of pages. Each of the pages may include a plurality of memory cells to which a plurality of word lines (WL) are electrically coupled. The memory device 150 may be a nonvolatile memory device, for example, a flash memory. The flash memory may have a three-dimensional (3D) stack structure. The structure of the memory device 150 and the three-dimensional (3D) stack structure of the memory device 150 will be described later in detail with reference to FIGS. 2 to 11.

The controller 130 of the memory system 110 may control the memory device 150 in response to a request from the host 102. The controller 130 may provide the data read from the memory device 150, to the host 102, and store the data provided from the host 102 into the memory device 150. To this end, the controller 130 may control overall operations of the memory device 150, such as read, write, program and erase operations.

In detail, the controller 130 may include a host interface unit 132, a processor 134, an error correction code (ECC) unit 138, a power management unit 140, a NAND flash controller 142, and a memory 144.

The host interface unit 132 may process commands and data provided from the host 102, and may communicate with the host 102 through at least one of various interface protocols such as universal serial bus (USB), multimedia card (MMC), peripheral component interconnect-express (PCI-E), serial attached SCSI (SAS), serial advanced technology attachment (SATA), parallel advanced technology attachment (PATA), small computer system interface (SCSI), enhanced small disk interface (ESDI), and integrated drive electronics (IDE).

The ECC unit 138 may detect and correct errors in the data read from the memory device 150 during the read operation. The ECC unit 138 may not correct error bits when the number of the error bits is greater than or equal to a threshold number of correctable error bits, and may output an error correction fail signal indicating failure in correcting the error bits.

The ECC unit 138 may perform an error correction operation based on a coded modulation such as a low density parity check (LDPC) code, a Bose-Chaudhuri-Hocquenghem (BCH) code, a turbo code, a Reed-Solomon (RS) code, a convolution code, a recursive systematic code (RSC), a trellis-coded modulation (TCM), a Block coded modulation (BCM), and so on. The ECC unit 138 may include all circuits, systems or devices for the error correction operation.

The PMU 140 may provide and manage power for the controller 130, that is, power for the component elements included in the controller 130.

The NFC 142 may serve as a memory interface between the controller 130 and the memory device 150 to allow the controller 130 to control the memory device 150 in response to a request from the host 102. The NFC 142 may generate control signals for the memory device 150 and process data under the control of the processor 134 when the memory device 150 is a flash memory and, in particular, when the memory device 150 is a NAND flash memory.

The memory 144 may serve as a working memory of the memory system 110 and the controller 130, and store data for driving the memory system 110 and the controller 130. The controller 130 may control the memory device 150 in response to a request from the host 102. For example, the controller 130 may provide the data read from the memory device 150 to the host 102 and store the data provided from the host 102 in the memory device 150. When the controller 130 controls the operations of the memory device 150, the memory 144 may store data used by the controller 130 and the memory device 150 for such operations as read, write, program and erase operations.

The memory 144 may be implemented with volatile memory. The memory 144 may be implemented with a static random access memory (SRAM) or a dynamic random access memory (DRAM). As described above, the memory 144 may store data used by the host 102 and the memory device 150 for the read and write operations. To store the data, the memory 144 may include a program memory, a data memory, a write buffer, a read buffer, a map buffer, and so forth.

The processor 134 may control general operations of the memory system 110, and a write operation or a read operation for the memory device 150, in response to a write request or a read request from the host 102. The processor 134 may drive firmware, which is referred to as a flash translation layer (FTL), to control the general operations of the memory system 110. The processor 134 may be implemented with a microprocessor or a central processing unit (CPU).

A management unit (not shown) may be included in the processor 134, and may perform bad block management of the memory device 150. The management unit may find bad memory blocks included in the memory device 150, which are in unsatisfactory condition for further use, and perform bad block management on the bad memory blocks. When the memory device 150 is a flash memory, for example, a NAND flash memory, a program failure may occur during the write operation, for example, during the program operation, due to characteristics of a NAND logic function. During the bad block management, the data of the program-failed memory block or the bad memory block may be programmed into a new memory block. Also, the bad blocks due to the program fail seriously deteriorates the utilization efficiency of the memory device 150 having a 3D stack structure and the reliability of the memory system 100, and thus reliable bad block management is required.

FIG. 2 is a schematic diagram illustrating the memory device 150 shown in FIG. 1.

Referring to FIG. 2, the memory device 150 may include a plurality of memory blocks, for example, zeroth to (N−1)^{th} blocks 210 to 240. Each of the plurality of memory blocks 210 to 240 may include a plurality of pages, for example, 2^{M} number of pages (2^{M} PAGES), to which the present invention will not be limited. Each of the plurality of pages may include a plurality of memory cells to which a plurality of word lines are electrically coupled.

Also, the memory device 150 may include a plurality of memory blocks, as single level cell (SLC) memory blocks and multi-level cell (MLC) memory blocks, according to the number of bits which may be stored or expressed in each memory cell. The SLC memory block may include a plurality of pages which are implemented with memory cells each capable of storing 1-bit data. The MLC memory block may include a plurality of pages which are implemented with memory cells each capable of storing multi-bit data, for example, two or more-bit data. An MLC memory block including a plurality of pages which are implemented with memory cells that are each capable of storing 3-bit data may be defined as a triple level cell (TLC) memory block.

Each of the plurality of memory blocks 210 to 240 may store the data provided from the host device 102 during a write operation, and may provide stored data to the host 102 during a read operation.

FIG. 3 is a circuit diagram illustrating one of the plurality of memory blocks 152 to 156 shown in FIG. 1.

Referring to FIG. 3, the memory block 152 of the memory device 150 may include a plurality of cell strings 340 which are electrically coupled to bit lines BL0 to BLm-1, respectively. The cell string 340 of each column may include at least one drain select transistor DST and at least one source select transistor SST. A plurality of memory cells or a plurality of memory cell transistors MC0 to MCn-1 may be electrically coupled in series between the select transistors DST and SST. The respective memory cells MC0 to MCn-1 may be configured by multi-level cells (MLC) each of which stores data information of a plurality of bits. The strings 340 may be electrically coupled to the corresponding bit lines BL0 to BLm-1, respectively. For reference, in FIG. 3, ‘DSL’ denotes a drain select line, ‘SSL’ denotes a source select line, and ‘CSL’ denotes a common source line.

While FIG. 3 shows, as an example, the memory block 152 which is configured by NAND flash memory cells, it is to be noted that the memory block 152 of the memory device 150 according to the embodiment is not limited to NAND flash memory and may be realized by NOR flash memory, hybrid flash memory in which at least two kinds of memory cells are combined, or one-NAND flash memory in which a controller is built in a memory chip. The operational characteristics of a semiconductor device may be applied to not only a flash memory device in which a charge storing layer is configured by conductive floating gates but also a charge trap flash (CTF) in which a charge storing layer is configured by a dielectric layer.

A voltage supply block 310 of the memory device 150 may provide word line voltages, for example, a program voltage, a read voltage and a pass voltage, to be supplied to respective word lines according to an operation mode and voltages to be supplied to bulks, for example, well regions in which the memory cells are formed. The voltage supply block 310 may perform a voltage generating operation under the control of a control circuit (not shown). The voltage supply block 310 may generate a plurality of variable read voltages to generate a plurality of read data, select one of the memory blocks or sectors of a memory cell array under the control of the control circuit, select one of the word lines of the selected memory block, and provide the word line voltages to the selected word line and unselected word lines.

A read/write circuit 320 of the memory device 150 may be controlled by the control circuit, and may serve as a sense amplifier or a write driver according to an operation mode. During a verification/normal read operation, the read/write circuit 320 may serve as a sense amplifier for reading data from the memory cell array. Also, during a program operation, the read/write circuit 320 may serve as a write driver which drives bit lines according to data to be stored in the memory cell array. The read/write circuit 320 may receive data to be written in the memory cell array, from a buffer (not shown), during the program operation, and may drive the bit lines according to the inputted data. To this end, the read/write circuit 320 may include a plurality of page buffers 322, 324 and 326 respectively corresponding to columns (or bit lines) or pairs of columns (or pairs of bit lines), and a plurality of latches (not shown) may be included in each of the page buffers 322, 324 and 326.

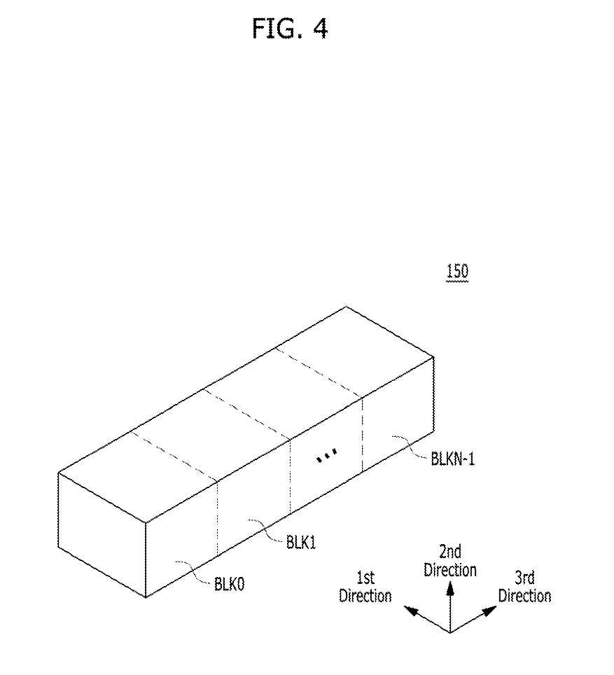

FIGS. 4 to 11 are schematic diagrams illustrating the memory device 150 shown in FIG. 1.

FIG. 4 is a block diagram illustrating an example of the plurality of memory blocks 152 to 156 of the memory device 150 shown in FIG. 1.

Referring to FIG. 4, the memory device 150 may include a plurality of memory blocks BLK0 to BLKN-1, and each of the memory blocks BLK0 to BLKN-1 may be realized in a three-dimensional (3D) structure or a vertical structure. The respective memory blocks BLK0 to BLKN-1 may include structures which extend in first to third directions, for example, an x-axis direction, a y-axis direction and a z-axis direction.

The respective memory blocks BLK0 to BLKN-1 may include a plurality of NAND strings NS which extend in the second direction. The plurality of NAND strings NS may be provided in the first direction and the third direction. Each NAND string NS may be electrically coupled to a bit line BL, at least one source select line SSL, at least one ground select line GSL, a plurality of word lines WL, at least one dummy word line DWL, and a common source line CSL. Namely, the respective memory blocks BLK0 to BLKN-1 may be electrically coupled to a plurality of bit lines BL, a plurality of source select lines SSL, a plurality of ground select lines GSL, a plurality of word lines WL, a plurality of dummy word lines DWL, and a plurality of common source lines CSL.

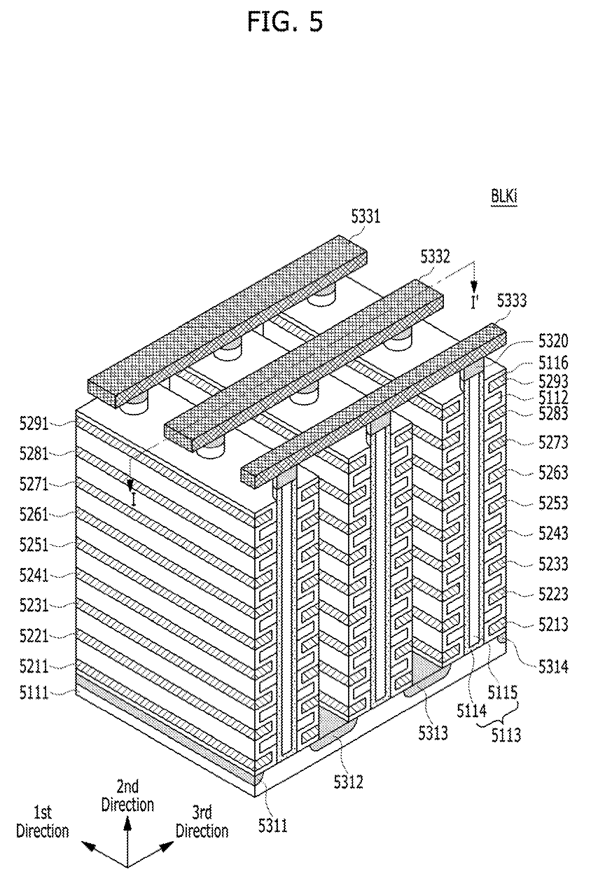

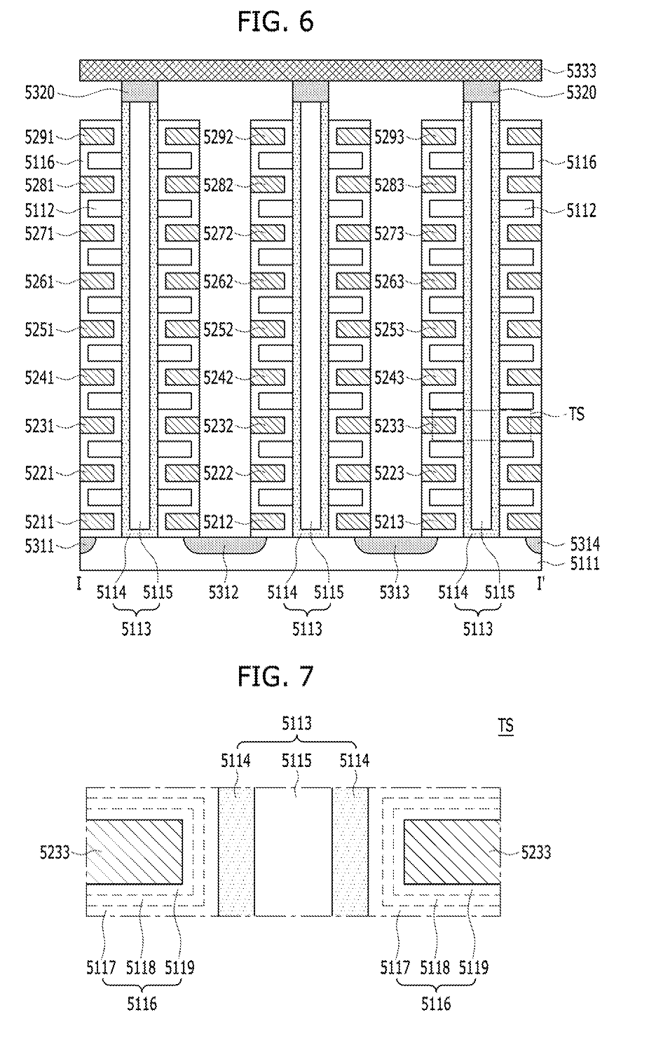

FIG. 5 is a perspective view of one BLKi of the plural memory blocks BLK0 to BLKN-1 shown in FIG. 4. FIG. 6 is a cross-sectional view taken along a line I-I′ of the memory block BLKi shown in FIG. 5.

Referring to FIGS. 5 and 6, a memory block BLKi among the plurality of memory blocks of the memory device 150 may include a structure which extends in the first to third directions.

A substrate 5111 may be provided. The substrate 5111 may include a silicon material doped with a first type impurity. The substrate 5111 may include a silicon material doped with a p-type impurity or may be a p-type well, for example, a pocket p-well, and include an n-type well which surrounds the p-type well. While it is assumed that the substrate 5111 is p-type silicon, it is to be noted that the substrate 5111 is not limited to being p-type silicon.

A plurality of doping regions 5311 to 5314 which extend in the first direction may be provided over the substrate 5111. The plurality of doping regions 5311 to 5314 may contain a second type of impurity that is different from the substrate 5111. The plurality of doping regions 5311 to 5314 may be doped with an n-type impurity. While it is assumed here that first to fourth doping regions 5311 to 5314 are n-type, it is to be noted that the first to fourth doping regions 5311 to 5314 are not limited to being n-type.

In the region over the substrate 5111 between the first and second doping regions 5311 and 5312, a plurality of dielectric materials 5112 which extend in the first direction may be sequentially provided in the second direction. The dielectric materials 5112 and the substrate 5111 may be separated from one another by a predetermined distance in the second direction. The dielectric materials 5112 may be separated from one another by a predetermined distance in the second direction. The dielectric materials 5112 may include a dielectric material such as silicon oxide.

In the region over the substrate 5111 between the first and second doping regions 5311 and 5312, a plurality of pillars 5113 which are sequentially disposed in the first direction and pass through the dielectric materials 5112 in the second direction may be provided. The plurality of pillars 5113 may respectively pass through the dielectric materials 5112 and may be electrically coupled with the substrate 5111. Each pillar 5113 may be configured by a plurality of materials. The surface layer 5114 of each pillar 5113 may include a silicon material doped with the first type of impurity. The surface layer 5114 of each pillar 5113 may include a silicon material doped with the same type of impurity as the substrate 5111. While it is assumed here that the surface layer 5114 of each pillar 5113 may include p-type silicon, the surface layer 5114 of each pillar 5113 is not limited to being p-type silicon.

An inner layer 5115 of each pillar 5113 may be formed of a dielectric material. The inner layer 5115 of each pillar 5113 may be filled by a dielectric material such as silicon oxide.

In the region between the first and second doping regions 5311 and 5312, a dielectric layer 5116 may be provided along the exposed surfaces of the dielectric materials 5112, the pillars 5113 and the substrate 5111. The thickness of the dielectric layer 5116 may be less than half of the distance between the dielectric materials 5112. In other words, a region in which a material other than the dielectric material 5112 and the dielectric layer 5116 may be disposed, may be provided between (i) the dielectric layer 5116 provided over the bottom surface of a first dielectric material of the dielectric materials 5112 and (ii) the dielectric layer 5116 provided over the top surface of a second dielectric material of the dielectric materials 5112. The dielectric materials 5112 lie below the first dielectric material.

In the region between the first and second doping regions 5311 and 5312, conductive materials 5211 to 5291 may be provided over the exposed surface of the dielectric layer 5116. The conductive material 5211 which extends in the first direction may be provided between the dielectric material 5112 adjacent to the substrate 5111 and the substrate 5111. In particular, the conductive material 5211 which extends in the first direction may be provided between (i) the dielectric layer 5116 disposed over the substrate 5111 and (ii) the dielectric layer 5116 disposed over the bottom surface of the dielectric material 5112 adjacent to the substrate 5111.

The conductive material which extends in the first direction may be provided between (i) the dielectric layer 5116 disposed over the top surface of one of the dielectric materials 5112 and (ii) the dielectric layer 5116 disposed over the bottom surface of another dielectric material of the dielectric materials 5112, which is disposed over the certain dielectric material 5112. The conductive materials 5221 to 5281 which extend in the first direction may be provided between the dielectric materials 5112. The conductive material 5291 which extends in the first direction may be provided over the uppermost dielectric material 5112. The conductive materials 5211 to 5291 which extend in the first direction may be a metallic material. The conductive materials 5211 to 5291 which extend in the first direction may be a conductive material such as polysilicon.

In the region between the second and third doping regions 5312 and 5313, the same structures as the structures between the first and second doping regions 5311 and 5312 may be provided. For example, in the region between the second and third doping regions 5312 and 5313, the plurality of dielectric materials 5112 which extend in the first direction, the plurality of pillars 5113 which are sequentially arranged in the first direction and pass through the plurality of dielectric materials 5112 in the second direction, the dielectric layer 5116 which is provided over the exposed surfaces of the plurality of dielectric materials 5112 and the plurality of pillars 5113, and the plurality of conductive materials 5212 to 5292 which extend in the first direction may be provided.

In the region between the third and fourth doping regions 5313 and 5314, the same structures as between the first and second doping regions 5311 and 5312 may be provided. For example, in the region between the third and fourth doping regions 5313 and 5314, the plurality of dielectric materials 5112 which extend in the first direction, the plurality of pillars 5113 which are sequentially arranged in the first direction and pass through the plurality of dielectric materials 5112 in the second direction, the dielectric layer 5116 which is provided over the exposed surfaces of the plurality of dielectric materials 5112 and the plurality of pillars 5113, and the plurality of conductive materials 5213 to 5293 which extend in the first direction may be provided.

Drains 5320 may be respectively provided over the plurality of pillars 5113. The drains 5320 may be silicon materials doped with second type impurities. The drains 5320 may be silicon materials doped with n-type impurities. While it is assumed for the sake of convenience that the drains 5320 include n-type silicon, it is to be noted that the drains 5320 are not limited to being n-type silicon. For example, the width of each drain 5320 may be larger than the width of each corresponding pillar 5113. Each drain 5320 may be provided in the shape of a pad over the top surface of each corresponding pillar 5113.

Conductive materials 5331 to 5333 which extend in the third direction may be provided over the drains 5320. The conductive materials 5331 to 5333 may be sequentially disposed in the first direction. The respective conductive materials 5331 to 5333 may be electrically coupled with the drains 5320 of corresponding regions. The drains 5320 and the conductive materials 5331 to 5333 which extend in the third direction may be electrically coupled with through contact plugs. The conductive materials 5331 to 5333 which extend in the third direction may be a metallic material. The conductive materials 5331 to 5333 which extend in the third direction may be a conductive material such as polysilicon.

In FIGS. 5 and 6, the respective pillars 5113 may form strings together with the dielectric layer 5116 and the conductive materials 5211 to 5291, 5212 to 5292 and 5213 to 5293 which extend in the first direction. The respective pillars 5113 may form NAND strings NS together with the dielectric layer 5116 and the conductive materials 5211 to 5291, 5212 to 5292 and 5213 to 5293 which extend in the first direction. Each NAND string NS may include a plurality of transistor structures TS.

FIG. 7 is a cross-sectional view of the transistor structure TS shown in FIG. 6.

Referring to FIG. 7, in the transistor structure TS shown in FIG. 6, the dielectric layer 5116 may include first to third sub dielectric layers 5117, 5118 and 5119.

The surface layer 5114 of p-type silicon in each of the pillars 5113 may serve as a body. The first sub dielectric layer 5117 adjacent to the pillar 5113 may serve as a tunneling dielectric layer, and may include a thermal oxidation layer.

The second sub dielectric layer 5118 may serve as a charge storing layer. The second sub dielectric layer 5118 may serve as a charge capturing layer, and may include a nitride layer or a metal oxide layer such as an aluminum oxide layer, a hafnium oxide layer, or the like.

The third sub dielectric layer 5119 adjacent to the conductive material 5233 may serve as a blocking dielectric layer. The third sub dielectric layer 5119 adjacent to the conductive material 5233 which extends in the first direction may be formed as a single layer or multiple layers. The third sub dielectric layer 5119 may be a high-k dielectric layer such as an aluminum oxide layer, a hafnium oxide layer, or the like, which has a dielectric constant greater than the first and second sub dielectric layers 5117 and 5118.

The conductive material 5233 may serve as a gate or a control gate. That is, the gate or the control gate 5233, the blocking dielectric layer 5119, the charge storing layer 5118, the tunneling dielectric layer 5117 and the body 5114 may form a transistor or a memory cell transistor structure. For example, the first to third sub dielectric layers 5117 to 5119 may form an oxide-nitride-oxide (ONO) structure. In the embodiment, for the sake of convenience, the surface layer 5114 of p-type silicon in each of the pillars 5113 will be referred to as a body in the second direction.

The memory block BLKi may include the plurality of pillars 5113. Namely, the memory block BLKi may include the plurality of NAND strings NS. In detail, the memory block BLKi may include the plurality of NAND strings NS which extend in the second direction or a direction perpendicular to the substrate 5111.

Each NAND string NS may include the plurality of transistor structures TS which are disposed in the second direction. At least one of the plurality of transistor structures TS of each NAND string NS may serve as a string source transistor SST. At least one of the plurality of transistor structures TS of each NAND string NS may serve as a ground select transistor GST.

The gates or control gates may correspond to the conductive materials 5211 to 5291, 5212 to 5292 and 5213 to 5293 which extend in the first direction. In other words, the gates or the control gates may extend in the first direction and form word lines and at least two select lines, at least one source select line SSL and at least one ground select line GSL.

The conductive materials 5331 to 5333 which extend in the third direction may be electrically coupled to one end of the NAND strings NS. The conductive materials 5331 to 5333 which extend in the third direction may serve as bit lines BL. That is, in one memory block BLKi, the plurality of NAND strings NS may be electrically coupled to one bit line BL.

The second type doping regions 5311 to 5314 which extend in the first direction may be provided to the other ends of the NAND strings NS. The second type doping regions 5311 to 5314 which extend in the first direction may serve as common source lines CSL.

Namely, the memory block BLKi may include a plurality of NAND strings NS which extend in a direction perpendicular to the substrate 5111, e.g., the second direction, and may serve as a NAND flash memory block, for example, of a charge capturing type memory, in which a plurality of NAND strings NS are electrically coupled to one bit line BL.

While it is illustrated in FIGS. 5 to 7 that the conductive materials 5211 to 5291, 5212 to 5292 and 5213 to 5293 which extend in the first direction are provided in 9 layers, it is to be noted that the conductive materials 5211 to 5291, 5212 to 5292 and 5213 to 5293 which extend in the first direction are not limited to being provided in 9 layers. For example, conductive materials which extend in the first direction may be provided in 8 layers, 16 layers or any multiple of layers. In other words, in one NAND string NS, the number of transistors may be 8, 16 or more.

While it is illustrated in FIGS. 5 to 7 that 3 NAND strings NS are electrically coupled to one bit line BL, it is to be noted that the embodiment is not limited to having 3 NAND strings NS that are electrically coupled to one bit line BL. In the memory block BLKi, m number of NAND strings NS may be electrically coupled to one bit line BL, m being a positive integer. According to the number of NAND strings NS which are electrically coupled to one bit line BL, the number of conductive materials 5211 to 5291, 5212 to 5292 and 5213 to 5293 which extend in the first direction and the number of common source lines 5311 to 5314 may be controlled as well.

Further, while it is illustrated in FIGS. 5 to 7 that 3 NAND strings NS are electrically coupled to one conductive material which extends in the first direction, it is to be noted that the embodiment is not limited to having 3 NAND strings NS electrically coupled to one conductive material which extends in the first direction. For example, n number of NAND strings NS may be electrically coupled to one conductive material which extends in the first direction, n being a positive integer. According to the number of NAND strings NS which are electrically coupled to one conductive material which extends in the first direction, the number of bit lines 5331 to 5333 may be controlled as well.

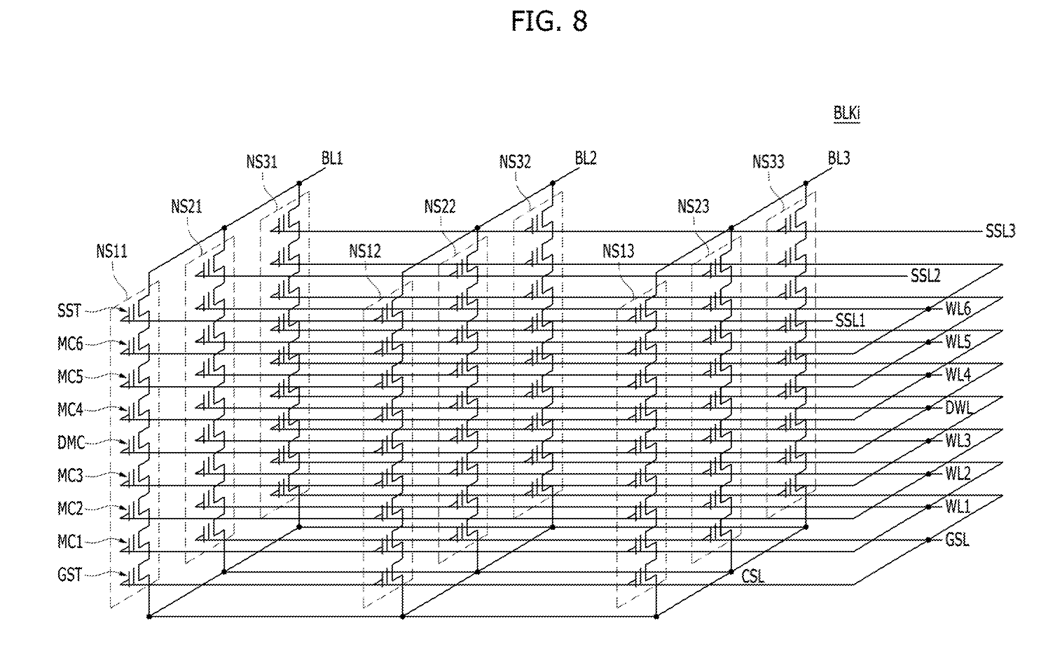

FIG. 8 is an equivalent circuit diagram illustrating the memory block BLKi having a first structure described with reference to FIGS. 5 to 7.

Referring to FIG. 8, in a block BLKi having the first structure, NAND strings NS11 to NS31 may be provided between a first bit line BL1 and a common source line CSL. The first bit line BL1 may correspond to the conductive material 5331 of FIGS. 5 and 6, which extends in the third direction. NAND strings NS12 to NS32 may be provided between a second bit line BL2 and the common source line CSL. The second bit line BL2 may correspond to the conductive material 5332 of FIGS. 5 and 6, which extends in the third direction. NAND strings NS13 to NS33 may be provided between a third bit line BL3 and the common source line CSL. The third bit line BL3 may correspond to the conductive material 5333 of FIGS. 5 and 6, which extends in the third direction.

A source select transistor SST of each NAND string NS may be electrically coupled to a corresponding bit line BL. A ground select transistor GST of each NAND string NS may be electrically coupled to the common source line CSL. Memory cells MC may be provided between the source select transistor SST and the ground select transistor GST of each NAND string NS.

In this example, NAND strings NS may be defined by units of rows and columns and NAND strings NS which are electrically coupled to one bit line may form one column. The NAND strings NS11 to NS31 which are electrically coupled to the first bit line BL1 may correspond to a first column, the NAND strings NS12 to NS32 which are electrically coupled to the second bit line BL2 may correspond to a second column, and the NAND strings NS13 to NS33 which are electrically coupled to the third bit line BL3 may correspond to a third column. NAND strings NS which are electrically coupled to one source select line SSL may form one row. The NAND strings NS11 to NS13 which are electrically coupled to a first source select line SSL1 may form a first row, the NAND strings NS21 to NS23 which are electrically coupled to a second source select line SSL2 may form a second row, and the NAND strings NS31 to NS33 which are electrically coupled to a third source select line SSL3 may form a third row.

In each NAND string NS, a height may be defined. In each NAND string NS, the height of a memory cell MC1 adjacent to the ground select transistor GST may have a value ‘1’. In each NAND string NS, the height of a memory cell may increase as the memory cell gets closer to the source select transistor SST when measured from the substrate 5111. In each NAND string NS, the height of a memory cell MC6 adjacent to the source select transistor SST may be 7.

The source select transistors SST of the NAND strings NS in the same row may share the source select line SSL. The source select transistors SST of the NAND strings NS in different rows may be respectively electrically coupled to the different source select lines SSL1, SSL2 and SSL3.

The memory cells at the same height in the NAND strings NS in the same row may share a word line WL. That is, at the same height, the word lines WL electrically coupled to the memory cells MC of the NAND strings NS in different rows may be electrically coupled. Dummy memory cells DMC at the same height in the NAND strings NS of the same row may share a dummy word line DWL. Namely, at the same height or level, the dummy word lines DWL electrically coupled to the dummy memory cells DMC of the NAND strings NS in different rows may be electrically coupled.

The word lines WL or the dummy word lines DWL located at the same level or height or layer may be electrically coupled with one another at layers where the conductive materials 5211 to 5291, 5212 to 5292 and 5213 to 5293 which extend in the first direction may be provided. The conductive materials 5211 to 5291, 5212 to 5292 and 5213 to 5293 which extend in the first direction may be electrically coupled in common to upper layers through contacts. At the upper layers, the conductive materials 5211 to 5291, 5212 to 5292 and 5213 to 5293 which extend in the first direction may be electrically coupled. In other words, the ground select transistors GST of the NAND strings NS in the same row may share the ground select line GSL. Further, the ground select transistors GST of the NAND strings NS in different rows may share the ground select line GSL. That is, the NAND strings NS11 to NS13, NS21 to NS23 and NS31 to NS33 may be electrically coupled to the ground select line GSL.

The common source line CSL may be electrically coupled to the NAND strings NS. Over the active regions and over the substrate 5111, the first to fourth doping regions 5311 to 5314 may be electrically coupled. The first to fourth doping regions 5311 to 5314 may be electrically coupled to an upper layer through contacts and, at the upper layer, the first to fourth doping regions 5311 to 5314 may be electrically coupled.

Namely, as shown in FIG. 8, the word lines WL of the same height or level may be electrically coupled. Accordingly, when a word line WL at a specific height is selected, all NAND strings NS which are electrically coupled to the word line WL may be selected. The NAND strings NS in different rows may be electrically coupled to different source select lines SSL. Accordingly, among the NAND strings NS electrically coupled to the same word line WL, by selecting one of the source select lines SSL1 to SSL3, the NAND strings NS in the unselected rows may be electrically isolated from the bit lines BL1 to BL3. In other words, by selecting one of the source select lines SSL1 to SSL3, a row of NAND strings NS may be selected. Moreover, by selecting one of the bit lines BL1 to BL3, the NAND strings NS in the selected rows may be selected in units of columns.

In each NAND string NS, a dummy memory cell DMC may be provided. In FIG. 8, the dummy memory cell DMC may be provided between a third memory cell MC3 and a fourth memory cell MC4 in each NAND string NS. That is, first to third memory cells MC1 to MC3 may be provided between the dummy memory cell DMC and the ground select transistor GST. Fourth to sixth memory cells MC4 to MC6 may be provided between the dummy memory cell DMC and the source select transistor SST. The memory cells MC of each NAND string NS may be divided into memory cell groups by the dummy memory cell DMC. In the divided memory cell groups, memory cells, for example, MC1 to MC3, adjacent to the ground select transistor GST may be referred to as a lower memory cell group, and memory cells, for example, MC4 to MC6, adjacent to the string select transistor SST may be referred to as an upper memory cell group.

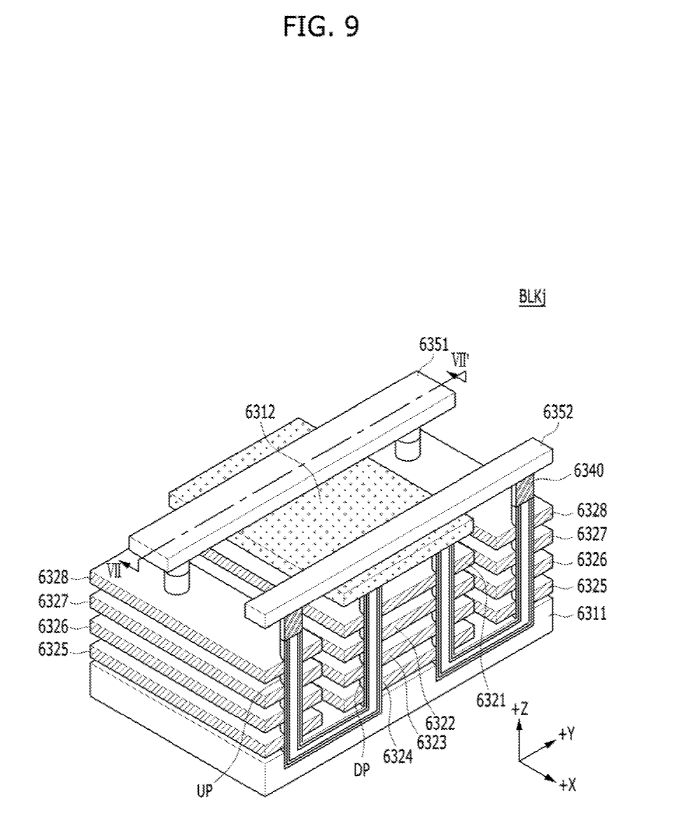

Hereinbelow, detailed descriptions will be made with reference to FIGS. 9 to 11, which show the memory device in the memory system according to an embodiment implemented with a three-dimensional (3D) nonvolatile memory device different from the first structure.

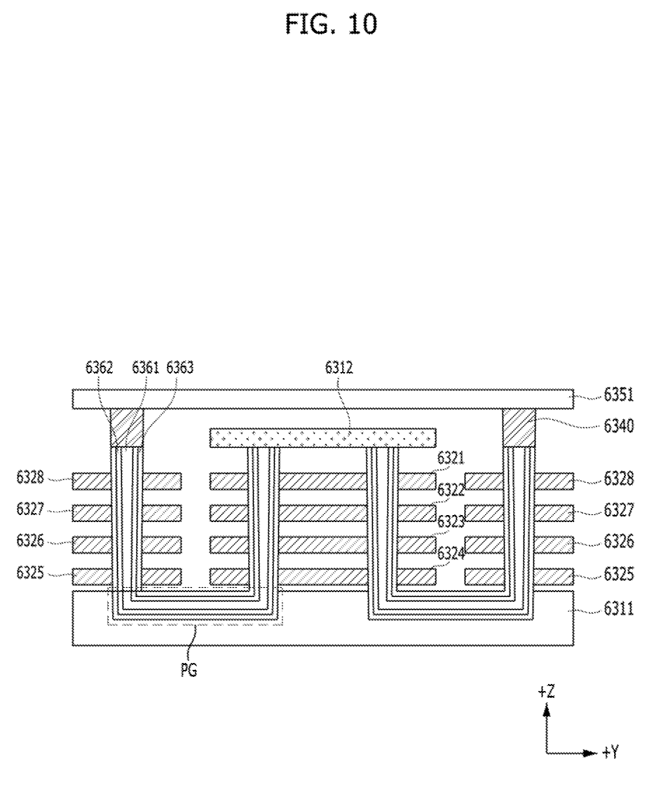

FIG. 9 is a perspective view schematically illustrating the memory device implemented with the three-dimensional (3D) nonvolatile memory device, which is different from the first structure described above with reference to FIGS. 5 to 8, and showing a memory block BLKj of the plurality of memory blocks of FIG. 4. FIG. 10 is a cross-sectional view illustrating the memory block BLKj taken along the line VII-VII′ of FIG. 9.

Referring to FIGS. 9 and 10, the memory block BLKj among the plurality of memory blocks of the memory device 150 of FIG. 1 may include structures which extend in the first to third directions.

A substrate 6311 may be provided. For example, the substrate 6311 may include a silicon material doped with a first type impurity. For example, the substrate 6311 may include a silicon material doped with a p-type impurity or may be a p-type well, for example, a pocket p-well, and include an n-type well which surrounds the p-type well. While it is assumed in the embodiment for the sake of convenience that the substrate 6311 is p-type silicon, it is to be noted that the substrate 6311 is not limited to being p-type silicon.

First to fourth conductive materials 6321 to 6324 which extend in the x-axis direction and the y-axis direction are provided over the substrate 6311. The first to fourth conductive materials 6321 to 6324 may be separated by a predetermined distance in the z-axis direction.

Fifth to eighth conductive materials 6325 to 6328 which extend in the x-axis direction and the y-axis direction may be provided over the substrate 6311. The fifth to eighth conductive materials 6325 to 6328 may be separated by the predetermined distance in the z-axis direction. The fifth to eighth conductive materials 6325 to 6328 may be separated from the first to fourth conductive materials 6321 to 6324 in the y-axis direction.

A plurality of lower pillars DP which pass through the first to fourth conductive materials 6321 to 6324 may be provided. Each lower pillar DP extends in the z-axis direction. Also, a plurality of upper pillars UP which pass through the fifth to eighth conductive materials 6325 to 6328 may be provided. Each upper pillar UP extends in the z-axis direction.

Each of the lower pillars DP and the upper pillars UP may include an internal material 6361, an intermediate layer 6362, and a surface layer 6363. The intermediate layer 6362 may serve as a channel of the cell transistor. The surface layer 6363 may include a blocking dielectric layer, a charge storing layer and a tunneling dielectric layer.

The lower pillar DP and the upper pillar UP may be electrically coupled through a pipe gate PG. The pipe gate PG may be disposed in the substrate 6311. For instance, the pipe gate PG may include the same material as the lower pillar DP and the upper pillar UP.

A doping material 6312 of a second type which extends in the x-axis direction and the y-axis direction may be provided over the lower pillars DP. For example, the doping material 6312 of the second type may include an n-type silicon material. The doping material 6312 of the second type may serve as a common source line CSL.

Drains 6340 may be provided over the upper pillars UP. The drains 6340 may include an n-type silicon material. First and second upper conductive materials 6351 and 6352 which extend in the y-axis direction may be provided over the drains 6340.

The first and second upper conductive materials 6351 and 6352 may be separated in the x-axis direction. The first and second upper conductive materials 6351 and 6352 may be formed of a metal. The first and second upper conductive materials 6351 and 6352 and the drains 6340 may be electrically coupled through contact plugs. The first and second upper conductive materials 6351 and 6352 respectively serve as first and second bit lines BL1 and BL2.

The first conductive material 6321 may serve as a source select line SSL, the second conductive material 6322 may serve as a first dummy word line DWL1, and the third and fourth conductive materials 6323 and 6324 serve as first and second main word lines MWL1 and MWL2, respectively. The fifth and sixth conductive materials 6325 and 6326 serve as third and fourth main word lines MWL3 and MWL4, respectively, the seventh conductive material 6327 may serve as a second dummy word line DWL2, and the eighth conductive material 6328 may serve as a drain select line DSL.

The lower pillar DP and the first to fourth conductive materials 6321 to 6324 adjacent to the lower pillar DP form a lower string. The upper pillar UP and the fifth to eighth conductive materials 6325 to 6328 adjacent to the upper pillar UP form an upper string. The lower string and the upper string may be electrically coupled through the pipe gate PG. One end of the lower string may be electrically coupled to the doping material 6312 of the second type which serves as the common source line CSL. One end of the upper string may be electrically coupled to a corresponding bit line through the drain 6340. One lower string and one upper string form one cell string which is electrically coupled between the doping material 6312 of the second type serving as the common source line CSL and a corresponding one of the upper conductive material layers 6351 and 6352 serving as the bit line BL.

That is, the lower string may include a source select transistor SST, the first dummy memory cell DMC1, and the first and second main memory cells MMC1 and MMC2. The upper string may include the third and fourth main memory cells MMC3 and MMC4, the second dummy memory cell DMC2, and a drain select transistor DST.

In FIGS. 9 and 10, the upper string and the lower string may form a NAND string NS, and the NAND string NS may include a plurality of transistor structures TS. Since the transistor structure included in the NAND string NS in FIGS. 9 and 10 is described above in detail with reference to FIG. 7, a detailed description thereof will be omitted herein.

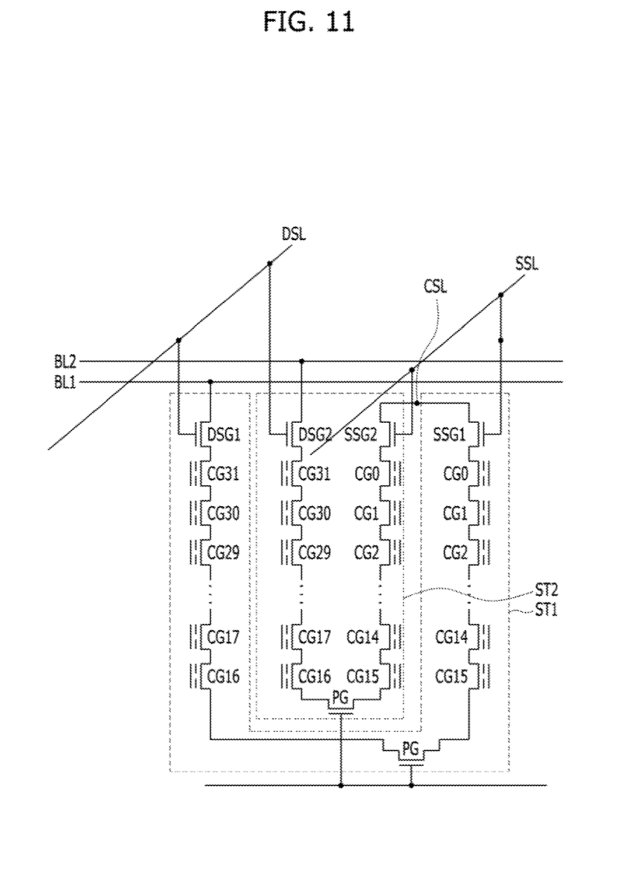

FIG. 11 is a circuit diagram illustrating the equivalent circuit of the memory block BLKj having the second structure as described above with reference to FIGS. 9 and 10. For the sake of convenience, only a first string and a second string, which form a pair in the memory block BLKj in the second structure are shown.

Referring to FIG. 11, in the memory block BLKj having the second structure among the plurality of blocks of the memory device 150, cell strings, each of which is implemented with one upper string and one lower string electrically coupled through the pipe gate PG as described above with reference to FIGS. 9 and 10, may be provided in such a way as to define a plurality of pairs.

Namely, in the certain memory block BLKj having the second structure, memory cells CG0 to CG31 stacked along a first channel CH1 (not shown), for example, at least one source select gate SSG1 and at least one drain select gate DSG1 may form a first string ST1, and memory cells CG0 to CG31 stacked along a second channel CH2 (not shown), for example, at least one source select gate SSG2 and at least one drain select gate DSG2 may form a second string ST2.

The first string ST1 and the second string ST2 may be electrically coupled to the same drain select line DSL and the same source select line SSL. The first string ST1 may be electrically coupled to a first bit line BL1, and the second string ST2 may be electrically coupled to a second bit line BL2.

While it is described in FIG. 11 that the first string ST1 and the second string ST2 are electrically coupled to the same drain select line DSL and the same source select line SSL, it may be envisaged that the first string ST1 and the second string ST2 may be electrically coupled to the same source select line SSL and the same bit line BL, the first string ST1 may be electrically coupled to a first drain select line DSL1 and the second string ST2 may be electrically coupled to a second drain select line DSL2. Further it may be envisaged that the first string ST1 and the second string ST2 may be electrically coupled to the same drain select line DSL and the same bit line BL, the first string ST1 may be electrically coupled to a first source select line SSL1 and the second string ST2 may be electrically coupled a second source select line SSL2.

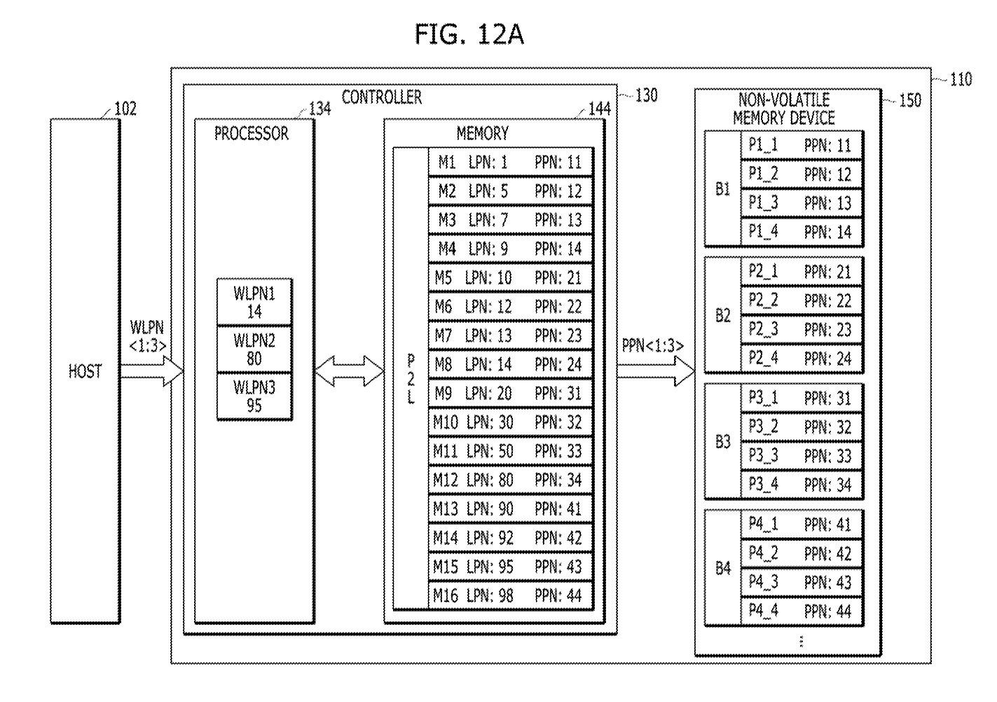

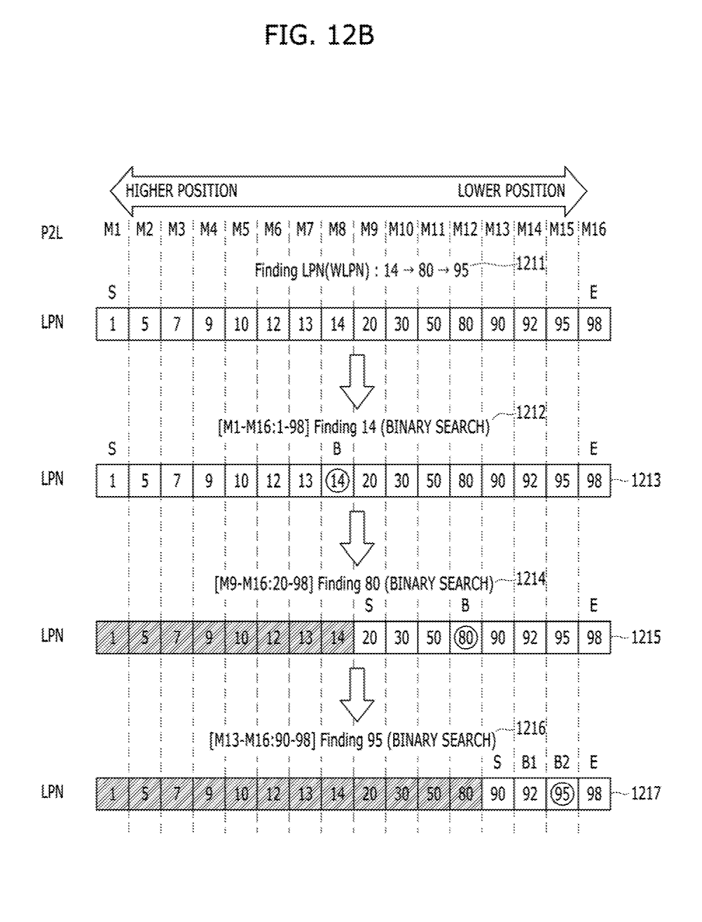

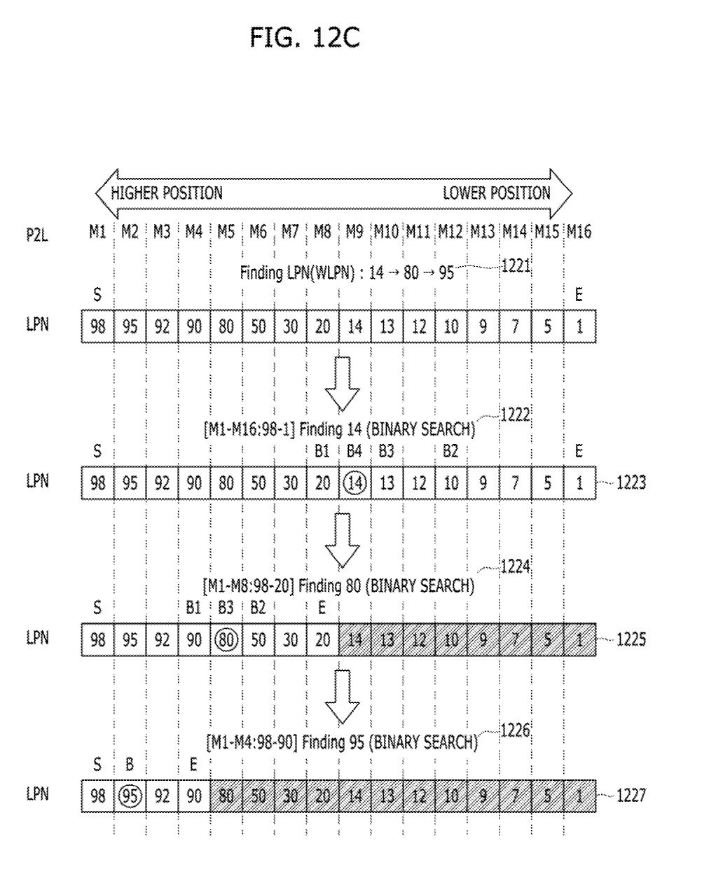

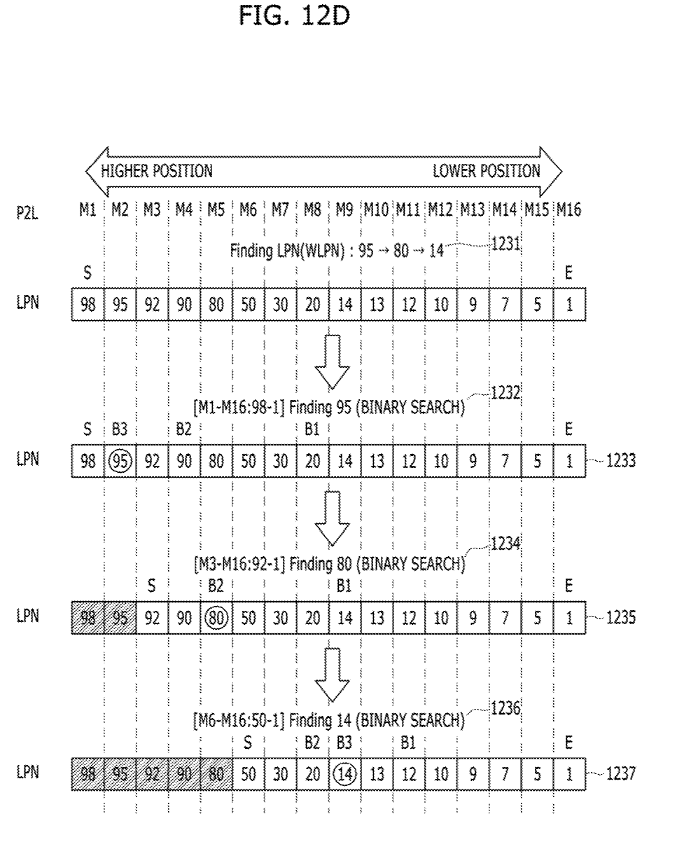

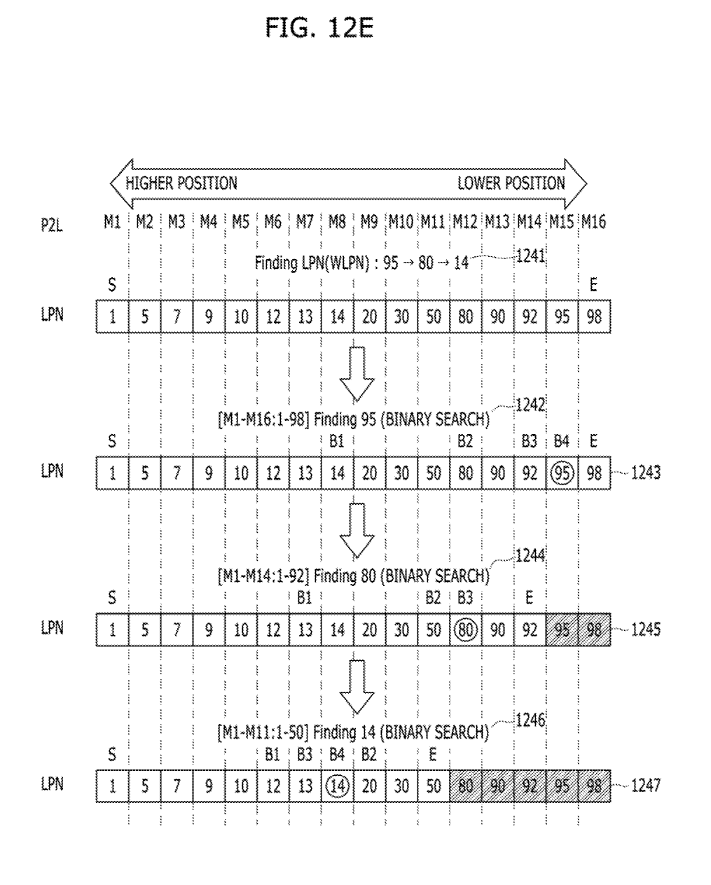

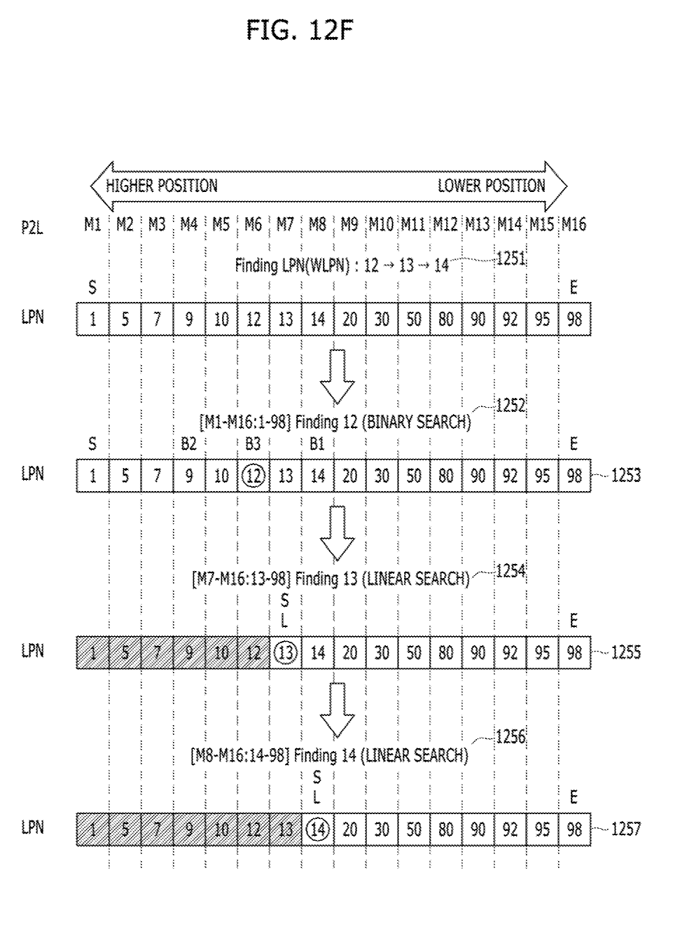

FIGS. 12A to 12F are diagrams illustrating examples of an operation of searching a mapping table for logical addresses requested by a host in a memory system according to embodiments of the present invention.

Referring to FIG. 12A, there is shown the memory system 110 of FIG. 1, performing an operation for searching an address mapping table P2L for requested logical addresses WLPN<1:3> by the host 102. The memory system 110 may include the non-volatile memory device 150 and the controller 130. Furthermore, the controller 130 may include the processor 134 and the memory 144. In this case, the ECC unit 138, the power management unit 140, the host interface 132, and the NAND flash controller 142 have been illustrated as being included in the controller 130 in FIG. 1, but have been illustrated as not being included in the controller 130 in FIG. 12A. This is only for convenience of description, and it is noted, that controller 130 may include the ECC unit 138, the power management unit 140, the host interface 132, and the NAND flash controller 142.

The non-volatile memory device 150 may include a plurality of blocks B<1:4>. The plurality of blocks B<1:4> may include a plurality of pages P1_<1:4>, P2_<1:4>, P3_<1:4>, and P4_<1:4>, respectively. In this case, a plurality of physical addresses PPN corresponding to the non-volatile memory device 150 may be set in a form to indicate the plurality of blocks B<1:4>. The plurality of physical addresses PPN corresponding to the non-volatile memory device 150 may be set in a form to indicate the plurality of pages P1_<1:4>, P2_<1:4>, P3_<1:4>, and P4_<1:4> in each respective block. For example, assuming that the plurality of physical addresses PPN is indicative of a plurality of storage regions included in the non-volatile memory device 150, the plurality of storage regions may be the plurality of blocks B<1:4> or the plurality of pages P1_<1:4>, P2_<1:4>, P3_<1:4>, and P4_<1:4>. For reference, in FIG. 12A, the plurality of physical addresses PPN has been set in a form to indicate the plurality of pages P1_<1:4>, P2_<1:4>, P3_<1:4>, and P4_<1:4>. Accordingly, in the following description, the plurality of storage regions is assumed to be the plurality of pages P1_<1:4>, P2_<1:4>, P3_<1:4>, and P4_<1:4>.

The controller 130 may select storage regions indicated by the logical addresses WLPN<1:3>, requested by the host 102, from the plurality of storage regions P1_<1:4>, P2_<1:4>, P3_<1:4> and P4_<1:4> by using the mapping table P2L. The mapping table P2L has stored therein a plurality of pieces of mapping information M<1:16> for mapping a plurality of logical addresses LPN used in the host 102 to the plurality of physical addresses PPN which correspond to the plurality of storage regions P1_<1:4>, P2_<1:4>, P3_<1:4>, and P4_<1:4>.

For translating the logical addresses WLPN<1:3>, requested by the host 102, into the physical addresses PPN through the mapping table P2L, the controller may search for the values of logical addresses LPN included in the plurality of pieces of mapping information M<1:16> stored in the mapping table P2L and identify logical addresses LPN included in the mapping information which have the same values with the requested logical addresses. If, as a result of the search, logical addresses LPN having the same values as the requested logical addresses WLPN<1:3> are found, corresponding physical addresses PPN which are mapped to the logical addresses LPN having the same values may be found.

For example, assuming that a single logical address WLPN1 requested by the host 102 has a value of ‘14’, the controller 130 may search the mapping table P2L for a mapping information M<1:16> having the same value ‘14’. The controller 130 may then identify a logical address LPN included in the eighth mapping information M8 of the mapping table P2L as having the value of ‘14’. Then, as described above, a physical address PPN having a value of ‘24’ mapped to the logical address LPN having the value of ‘14’ may be identified through the eighth mapping information M8. Accordingly, the fourth page P<2_4> of the second block B2 of the non-volatile memory device 150 which corresponds to the physical address PPN having the value of ‘24’ may be selected.

If three requested logical addresses WLPN<1:3> by the host 102 need to be sequentially searched for in the mapping table P2L, the controller 130 may control the range in which the second or later requested logical address WLPN<2 or 3> is to be searched for in the mapping table P2L depending on a position in which mapping information M<1:16> corresponding to the first or previously requested logical address WLPN<1 or 2> of the requested three logical addresses WLPN<1:3> has been stored in the mapping table P2L.

In order for the previously requested logical address WLPN<1 or 2> and the later requested logical address WLPN<2 or 3> to have different search ranges as described above, the controller 130 may align positions in which the plurality of pieces of mapping information M<1:16> is stored in the mapping table P2L based on the magnitude or size of the values of logical addresses LPN corresponding to the respective plurality of pieces of mapping information M<1:16>. Furthermore, the controller 130 may align the sequence in which the three requested logical addresses WLPN<1:3> by the host 102 are searched for in the mapping table P2L based on the magnitudes r sizes of the values of the three logical addresses WLPN<1:3>.

For example, from FIG. 12A, it may be seen that the logical addresses LPN included in the plurality of pieces of mapping information M<1:16> stored in the mapping table P2L are stored in higher positions as the logical addresses LPN have smaller values and the logical addresses LPN are stored in lower positions as the logical addresses LPN have greater values. The higher positions in the mapping table P2L represent positions with relatively lower index, while the lower positions in the mapping table P2L represent positions with relatively higher index. For example, in the highest position of the mapping table P2L, the mapping information is M1 and the corresponding logical address LPN has the value of ‘1’. In the lowest position of the mapping table P2L, the mapping information is M16 and the corresponding logical address LPN has the value of ‘98’. Furthermore, from FIG. 12A, it may be seen that the three requested logical addresses WLPN<1:3> by the host 102 are searched for in the mapping table P2L in an ascending value sequential order starting with the logical address WLPN1 having the smallest value ‘14’, followed by the WLPN2 having a value ‘80’ which is higher than ‘14’ and finally searching for the logical address WLPN3 having a value of ‘95’ which is the highest value among the values of the requested logical addresses.

If the positions in which the plurality of pieces of mapping information M<1:16> has been stored are not aligned in the mapping table P2L based on the magnitude or sizes of the values of the logical addresses LPN the controller 130 may perform an operation for aligning the positions in which the plurality of pieces of mapping information M<1:16> is stored in the mapping table P2L. Likewise, if the sequence in which a search for the logical addresses WLPN<1:3> has been requested is not aligned based on the magnitude or sizes of the values of the requested logical addresses WLPN<1:3>, the controller 130, may perform an operation for aligning the sequence in which a search for the logical addresses WLPN<1:3> has been requested according to the magnitude or size of the corresponding values of the requested logical addresses. In an embodiment, the controller 130 may align first the plurality of pieces of mapping information M<1:16> in an ascending order based on the magnitudes or sizes of their respective values, and may then align the sequence in which a search for the logical addresses WLPN<1:3> has been requested according to an ascending order of the magnitudes or sizes of the corresponding values of the requested logical addresses. It is noted, however, that the order of the aligning operations may be reversed. For example, in another embodiment the controller 130 may first align the sequence in which a search for the logical addresses WLPN<1:3> has been requested according to an ascending order of the magnitudes or sizes of the corresponding values of the requested logical addresses, and may then align the plurality of pieces of mapping information M<1:16> in an ascending order based on the magnitudes or sizes of their respective values. It is further noted, that in an embodiment, the controller may align the search request sequence and the mapping information M<1:16> in a descending order of their respective values.

FIG. 12B illustrates a sequence in which an operation is performed so that the previously requested logical address WLPN<1 or 2> and the later requested logical address WLPN<2 or 3> may have different search ranges.

First, as illustrated in FIG. 12A, the plurality of pieces of mapping information M<1:16> stored in the mapping table P2L has been stored in higher positions in the mapping table P2L as the mapping information M<1:16> includes respective logical addresses LPN having smaller values. For example, the logical address LPN having the smallest value ‘1’ is stored in the highest position of the mapping table P2L corresponding to the mapping information M<1>. The logical address LPN having the largest value ‘98’ is stored in the lowest position of the mapping table P2L corresponding to the mapping information M<16>. Furthermore, the three requested logical addresses WLPN<1:3> by the host 102 are searched for in order of 14->80->95 (1211) in the previous sequence, i.e., according to an ascending order of their respective value.

More specifically, when the logical address WLPN1 that belongs to the three requested logical addresses WLPN<1:3> by the host 102, that is requested in the first sequence, and that has the value of ‘14’ is searched for in the mapping table P2L, all the plurality of pieces of mapping information M<1:16> stored in the mapping table P2L belong to a search range S:1->E:98 (1212). That is, the search range of the first requested logical address WLPN1 having the value of ‘14’ may range from the first mapping information M1 that belongs to the plurality of pieces of mapping information M<1:16> and that is stored in the highest position of the mapping table P2L including a logical address LPN having a value of ‘1’ to the sixteenth mapping information M16 that belongs to the plurality of pieces of mapping information M<1:16> and that is stored in the lowest position of the mapping table P2L including a logical address LPN having a value of ‘98’.

It may be seen that when mapping information including logical addresses LPN having the same values as the first logical address WLPN1 having the value of ‘14’ is searched for using a binary search method in such a state, the eighth mapping information M8 among the plurality of pieces of mapping information M<1:16> includes the logical address LPN having the value of ‘14’ (1213).

Next, when the logical address WLPN2 having the value of ‘80’ is searched for in the mapping table P2L, all the pieces of the mapping information M<9:16> that belong to the plurality of pieces of mapping information M<1:16> stored in the mapping table P2L and that include logical addresses LPN having greater values than the value of the eighth mapping information M8 including the previously requested logical address LPN having the value of ‘14’ belong to a search range S:20->E:98 (1214). That is, the search range of the second requested logical address WLPN2 having the value of ‘80’ may range from the ninth mapping information M9 that belongs to the plurality of pieces of mapping information M<1:16>, that is stored in a one-step higher position than the eighth mapping information M8 including the previously requested logical address LPN having the value of ‘14’, and that includes a logical address LPN having a value of ‘20’ to the sixteenth mapping information M16 stored in the lowest position of the mapping table P2L, including the logical address LPN having the value of ‘98’.

The reason why a search can be completed without any problem although the search range of the second requested logical address WLPN2 having the value of ‘80’ is smaller than the search range of the first requested logical address WLPN1 having the value of ‘14’ as described above is that the plurality of pieces of mapping information M<1:16> stored in the mapping table P2L has been stored in higher positions in the mapping table P2L as the mapping information M<1:16> includes logical addresses LPN having smaller values and the three requested logical addresses WLPN<1:3> by the host 102 are searched for in order of 14->80->95 in the previous sequence according to a decrease in the values of the three logical addresses WLPN<1:3>.

That is, the first to seventh mapping information M<1:7> stored in higher positions than the eighth mapping information M8 including the logical address LPN having the same value ‘14’ as the first requested logical address WLPN1 include logical addresses LPN having values smaller than the value of ‘14’. For this reason, assuming that the second requested logical address WLPN2 has been aligned to have a greater value than the first requested logical address WLPN1, there is no possibility that logical addresses LPN having the same value as the second requested logical address WLPN2 may have been included in the first to eighth mapping information M<1:8>.

Accordingly, the second requested logical address WLPN2 may be sufficiently searched for in the ninth to sixteenth mapping information M<9:16> that include logical addresses LPN having smaller values than the logical address LPN of the eighth mapping information M8 and that are stored in lower positions.

From FIG. 12B, it may be seen that when mapping information including a logical address LPN having the same value as the second requested logical address WLPN2 having the value of ‘80’ is actually searched for using a binary search method in the state in which the ninth to sixteenth mapping information M<9:16> has been designated as a search range, the twelfth mapping information M12, that is, any one of the pieces of ninth to sixteenth mapping information M<9:16>, includes the logical address LPN having the value of ‘80’ (1215).

Next, when the logical address WLPN3 having the value of ‘95’ is searched for in the mapping table P2L, all of pieces of mapping information M<13:16> that belong to the plurality of pieces of mapping information M<1:16> stored in the mapping table P2L and that include logical addresses LPN having greater values than that of the twelfth mapping information M12 including the previously requested logical address LPN having the value of ‘80’ belong to a search range S:90->E:98 (1216). That is, the search range of the second requested logical address WLPN2 may range from the thirteenth mapping information M13 that belongs to the plurality of pieces of mapping information M<1:16>, that is stored in a one-step higher position than the twelfth mapping information M12 including the previously requested logical address LPN having the value of ‘80’, and that includes a logical address LPN having the value of ‘90’ to the sixteenth mapping information M16 stored in the lowest position of the mapping table P2L, including the logical address LPN having the value of ‘98’.

As described above, the reason why a search may be completed without any problem although the search range of the third requested logical address WLPN3 having the value of ‘95’ is smaller than the search range of the second requested logical address WLPN2 having the value of ‘80’ is that the plurality of pieces of mapping information M<1:16> stored in the mapping table P2L has been stored in higher positions in the mapping table P2L as the mapping information M<1:16> includes logical addresses LPN having smaller value and the three requested logical addresses WLPN<1:3> by the host 102 are searched for in order of 14->80->95 In the previous sequence according to a decrease in the values of the three logical addresses WLPN<1:3>.

That is, the first to eleventh mapping information M<1:11> stored in a higher position than the twelfth mapping information M12 including the logical address LPN having the same value ‘80’ as the second requested logical address WLPN2 include logical addresses LPN having smaller values than the value of ‘80’. For this reason, assuming that the third requested logical address WLPN3 has been aligned to have a greater value than the second requested logical address WLPN2, there is no possibility that a logical address LPN having the same value as the third requested logical address WLPN3 may have been include in the first to twelfth mapping information M<1:12>.

Accordingly, the third requested logical address WLPN3 may be sufficiently searched for in the thirteenth to sixteenth mapping information M<13:16> that include logical addresses LPN having smaller values than the logical address LPN of the twelfth mapping information M12 and that are stored in lower positions.

From FIG. 12B, it may be seen that when mapping information including a logical address LPN having the same value as the third requested logical address WLPN3 having the value of ‘95’ is actually searched for using a binary search method in the state in which the thirteenth to sixteenth mapping information M<13:16> has been designated as a search range, the fifteenth mapping information M15, that is, any one of the pieces of thirteenth to sixteenth mapping information M<13:16>, includes the logical address LPN having the value of ‘95’ (1217).

For reference, when the first requested logical address WLPN1 is searched for in the first to sixteenth mapping information M<1:16> (1212), the first requested logical address WLPN1 has been illustrated (1214) as being searched for at a time (B) through a binary search method because mapping information including a logical address LPN having the same value ‘14’ as the requested logical address WLPN1 is the eighth mapping information M8 that belongs to the first to sixteenth mapping information M<1:16>, that is, the search range, and that is placed on the left of the middle. Furthermore, when the second requested logical address WLPN2 is searched for in the ninth to sixteenth mapping information M<9:16> (1214), the second requested logical address WLPN2 has been illustrated as being searched (1215) for at a time (B) through a binary search method because mapping information including a logical address LPN having the same value ‘80’ as the requested logical address WLPN2 is the twelfth mapping information M12 that belongs to the ninth to sixteenth mapping information M<9:16>, that is, the search range, and that is placed on the left of the middle. Furthermore, when the third requested logical address WLPN3 is searched for in the thirteenth to sixteenth mapping information M<13:16> (1216), the third requested logical address WLPN3 is searched (1217) for twice (B1->B2) through a binary search method because mapping information including a logical address LPN having the same value ‘95’ as the requested logical address WLPN3 is the fifteenth mapping information M15 that belongs to the thirteenth to sixteenth mapping information M<13:16>, that is, the search range, and that is placed on the right of the middle. As described above, the illustrated binary search method is a widely known operation method, and a further description thereof is omitted.

As disclosed in the descriptions of FIGS. 12A and 12B, it may be seen that if the plurality of pieces of mapping information M<1:16> stored in the mapping table P2L has been stored in the higher positions of the mapping table P2L as they include logical addresses LPN having smaller values and the three requested logical addresses WLPN<1:3> by the host 102 are searched for in order of 14->80->95 in the previous sequence as they have smaller values, an operation may be performed so that the previously requested logical address WLPN<1 or 2> and the later requested logical address WLPN<2 or 3> have different search ranges.

In this case, if an alignment criterion for the positions in which the plurality of pieces of mapping information M<1:16> proposed in the descriptions of FIGS. 12A and 12B is stored in the mapping table P2L and an alignment criterion for sequence in which the requested logical addresses WLPN<1:3> by the host 102 are searched for are changed, a method of controlling the search range of the later requested logical address WLPN<2 or 3> compared to the previously requested logical address WLPN<1 or 2> may also be changed as in the following examples.

In the first example of FIG. 12C, the plurality of pieces of mapping information M<1:16> stored in the mapping table P2L are stored in lower positions of the mapping table P2L as they include logical addresses LPN having smaller values, and the three requested logical addresses WLPN<1:3> are searched for in order of 14->80->95 (1221) in previous sequence as they have smaller values. For example, the logical address LPN having the largest value ‘98’ is stored in the highest position of the mapping table P2L corresponding to the mapping information M<1>. The logical address LPN having the smallest value ‘1’ is stored in the lowest position of the mapping table P2L corresponding to the mapping information M<16>.

In this case, the later requested logical address WLPN<2 or 3> (e.g., 80 or 95) of the three requested logical addresses WLPN<1:3> has a greater value than the previously requested logical address WLPN<1 or 2> (e.g., 14 or 80), and logical addresses LPN included in pieces of mapping information stored in the higher positions of the mapping table P2L have greater values. Accordingly, as the search operation is performed, a search range is narrowed toward the pieces of mapping information stored in the higher positions of the mapping table P2L. That is, when the later requested logical address WLPN<2 or 3> of the three requested logical addresses WLPN<1:3> is searched for, it is searched for only in the pieces of mapping information stored in the positions (e.g., M1-M8 or M1-M4) of the mapping table P2L higher than the position (e.g., M1-M16 or M1-M8) in which mapping information including the previously requested logical address WLPN<1 or 2> has been stored.

In the second example of FIG. 12D, the plurality of pieces of mapping information M<1:16> stored in the mapping table P2L are stored in lower positions of the mapping table P2L as they include logical addresses LPN having smaller values, and the three requested logical addresses WLPN<1:3> are searched for in order of 95->80->14 (1231) in previous sequence as they have greater values. For example, the logical address LPN having the largest value ‘98’ is stored in the highest position of the mapping table P2L corresponding to the mapping information M<1>. The logical address LPN having the smallest value ‘1’ is stored in the lowest position of the mapping table P2L corresponding to the mapping information M<16>.

In this case, the later requested logical address WLPN<2 or 3> (e.g., 80 or 14) of the three requested logical addresses WLPN<1:3> has a smaller value than the previously requested logical address WLPN<1 or 2> (e.g., 95 or 80), and the logical addresses LPN included in the pieces of the mapping information stored in the lower positions of the mapping table P2L have smaller values. Accordingly, as the search operation is performed, a search range is narrowed toward the pieces of mapping information stored in the lower positions of the mapping table P2L. That is, when the later requested logical address WLPN<2 or 3> of the three requested logical addresses WLPN<1:3> is searched for, it is searched for only in the pieces of mapping information stored in the positions (e.g., M3-M16 or M6-M16) of the mapping table P2L lower than the position (e.g., M1-M16 or M3-M16) in which mapping information including the previously requested logical address WLPN<1 or 2> has been stored.

In the third example of FIG. 12E, the plurality of pieces of mapping information M<1:16> stored in the mapping table P2L are stored in the higher positions of the mapping table P2L as they include logical addresses LPN having smaller values, and the three requested logical addresses WLPN<1:3> are searched for in order of 95->80->14 (1241) in previous sequence as they have greater values. For example, the logical address LPN having the smallest value ‘1’ is stored in the highest position of the mapping table P2L corresponding to the mapping information M<1>. The logical address LPN having the largest value ‘98’ is stored in the lowest position of the mapping table P2L corresponding to the mapping information M<16>.

In this case, the later requested logical address WLPN<2 or 3> (e.g., 80 or 14) of the three requested logical addresses WLPN<1:3> has a smaller value than the previously requested logical address WLPN<1 or 2> (e.g., 95 or 80), and logical addresses LPN included in pieces of mapping information stored in the higher positions of the mapping table P2L have smaller values. Accordingly, as the search operation is performed, a search range is narrowed toward the pieces of mapping information stored in the higher positions of the mapping table P2L. That is, when the later requested logical address WLPN<2 or 3> of the three requested logical addresses WLPN<1:3> is searched for, it is searched for only in the pieces of mapping information stored in the positions (e.g., M1-M14 or M1-M11) of the mapping table P2L higher than the position (e.g., M1-M16 or M1-M14) in which mapping information including the previously requested logical address WLPN<1 or 2> has been stored.

A method of searching the logical addresses LPN included in the plurality of pieces of mapping information M<1:16> stored in the mapping table P2L, for the values of the requested logical addresses WLPN<1:3> may include a linear search method and a binary search method.

From FIG. 12B, it may be seen that the values of the requested logical addresses WLPN<1:3> may be searched for in the mapping table P2L using only a binary search method.

The reason for this is that the requested logical addresses WLPN<1:3> have the respective values ‘14’, ‘80’, and ‘95’ and a difference between the values is equal to or greater than a predetermined value. That is, the difference between the values of the previously requested logical address WLPN<1 or 2> (e.g., 14 or 80) and the later requested logical addresses WLPN<2 or 3> (e.g., 80 or 95) of the requested logical addresses WLPN<1:3> by the host 102 is equal to or greater than a predetermined value. Accordingly, the previously requested logical addresses WLPN<1 or 2> and the later requested logical address WLPN<2 or 3> may be searched for in the mapping table P2L using a binary search method.

However, unlike in the examples of FIGS. 12A to 12E, if a difference between the values of the requested logical addresses WLPN<1:3> is within a predetermined value, a combination of the binary search method and the linear search method may be used as it is illustrated in the example of FIG. 12F.

Referring to FIG. 12F, it may be seen that three logical addresses WLPN<1:3> have been requested by the host 102. The requested logical addresses WLPN<1:3> have respective values of ‘12’, ‘13’, and ‘14’ in the memory system 110 of FIG. 12A according to an embodiment of the present invention. That is, it may be seen that a difference between the values of the three requested logical addresses WLPN<1:3> is only ‘1’.

It may also be seen that logical addresses LPN included in the plurality of pieces of mapping information M<1:16> stored in the mapping table P2L are stored in higher positions as the logical addresses LPN have smaller values and are stored in lower positions as the logical addresses LPN have greater values. For example, the logical address LPN having the smallest value ‘1’ is stored in the highest position of the mapping table P2L corresponding to the mapping information M<1>. The logical address LPN having the largest value ‘98’ is stored in the lowest position of the mapping table P2L corresponding to the mapping information M<16>. From FIG. 12F, it may be seen that the three requested logical addresses WLPN<1:3> by the host 102 are searched for in the mapping table P2L in an ascending order of their respective values 12->13->14 starting with the logical address request having the smallest value.

More specifically, when the logical address WLPN1 having the value of ‘12’ is searched for in the mapping table P2L, all the plurality of pieces of mapping information M<1:16> stored in the mapping table P2L belong to a search range S:1->E:98 (1252). That is, the search range for the logical address WLPN1 may range from the first mapping information M1 stored in the highest position of the mapping table P2L, including the logical address LPN having the value of ‘1’, to the sixteenth mapping information M16 stored in the lowest position of the mapping table P2L including the logical address LPN having the value of ‘98’.

In this state, it may be seen that if the mapping information including a logical address LPN having the same value as the first logical address WLPN1 having the value of ‘12’ is searched for using the binary search method, the sixth mapping information M6 includes a logical address LPN having the value of ‘12’ (1253).

Next, when the logical address WLPN2 having the value of ‘13’ is searched for in the mapping table P2L, all the plurality of pieces of the mapping information M<7:16> that belong to the plurality of pieces of mapping information M<1:16> stored in the mapping table P2L and that include logical addresses LPN having greater values than a logical address LPN included in the sixth mapping information M6 including the previously requested logical address LPN having the value of ‘12’ belong to a search range S:13->E:98 (1254). That is, the seventh mapping information M7 that belongs to the plurality of pieces of mapping information M<1:16>, that is stored in a one-step higher position than the sixth mapping information M6 including the previously requested logical address LPN having the value of ‘12’, and that includes a logical address LPN having the value of ‘13’ to the sixteenth mapping information M16 stored in the lowest position of the mapping table P2L, including the logical address LPN having the value of ‘98’, belong to the search range of the second requested logical address WLPN2 having the value of ‘13’.

In this case, the linear search method (L in 1255) is used when the second requested logical address WLPN2 having the value of ‘13’ is searched for because there is a difference of only ‘1’ between the value of ‘13’ of the second requested logical address WLPN2 and the value of ‘12’ of the first requested logical address WLPN1 that has been previously searched for. That is, the second requested logical address WLPN2 having the value of ‘13’ is searched for using the linear search method in a range from the seventh mapping information M7 including the logical address LPN having the value of ‘13’ to the sixteenth mapping information M16 including the logical address LPN having the value of ‘98’, which have been designated as the search range (1255). It may be seen that as a result, the seventh mapping information M7 includes the logical address LPN having the value of ‘13’ in the first search.

Next, when the logical address WLPN3 that belongs to the three requested logical addresses WLPN<1:3> by the host 102, that is requested in the third sequence, and that has the value of ‘14’ is searched for in the mapping table P2L, all the plurality of pieces of mapping information M<8:16> that belong to the plurality of pieces of mapping information M<1:16> stored in the mapping table P2L and that include logical addresses LPN having greater values than the logical address LPN included in the seventh mapping information M7 Including the previously requested logical address LPN having the value of ‘13’ belong to a search range S:14->E:98 (1256). That is, the eighth mapping information M8 that belongs to the plurality of pieces of mapping information M<1:16>, that is stored in a one-step higher position than the seventh mapping information M7 including the previously requested logical address LPN having the value of ‘13’, and that includes a logical address LPN having the value of ‘14’ to the sixteenth mapping information M16 stored in the lowest position of the mapping table P2L, including a logical address LPN having the value of ‘98’, belong to the search range of the third requested logical address WLPN3 having the value of ‘14’.

In this case, the linear search method (L in 1257) is used when the third requested logical address WLPN3 having the value of ‘14’ is searched for because there is a difference of only ‘1’ between the value of ‘14’ of the third requested logical address WLPN3 and the value of ‘13’ of the second requested logical address WLPN2 that has been previously searched for. That is, the third requested logical address WLPN3 having the value of ‘14’ is searched for using the linear search method in a range from the eighth mapping information M8 including the logical address LPN having the value of ‘14’ to the sixteenth mapping information M16 including the logical address LPN having the value of ‘98’, which have been designated as the search range (1257). It may be seen that as a result, the eighth mapping information M8 includes the logical address LPN having the value of ‘14’ in the first search.

In the aforementioned embodiments, when the requested logical addresses WLPN<1:3> by the host 102 are searched for, an operation using consecutively a binary search method followed by a linear search method may be employed.

Referring back to FIG. 12A, it may be seen that the mapping table P2L may be stored in the memory 144 of the controller 130. Furthermore, it may be seen that an operation for searching the logical addresses LPN, respectively included in the plurality of pieces of mapping information M<1:16>, for the requested logical addresses WLPN<1:3> by the host 102 may be controlled by the processor 134.

Also, the number of pages P<1:16> included in the non-volatile memory device 150 has been illustrated as being 16 In FIG. 12A, but this is only for convenience of description. Thousands of or tens of thousands of pages may be included in the non-volatile memory device 150. Accordingly, in general, the magnitude or size of the mapping table P2L including mapping information about thousands of or tens of or thousands of pages has a magnitude or size that may not be stored in the memory 144 of the controller 130 at a time.

For this reason, in general, information about the entire mapping table P2L may be stored in a set space within the non-volatile memory device 150, and only the mapping table P2L including some mapping information may be organically loaded onto the memory 144 and used, if necessary.

Accordingly, in the aforementioned embodiments of the present invention, the requested logical addresses WLPN<1:3> by the host 102 may be searched for in the mapping table P2L stored in the memory 144. That is, the processor 134 may perform an operation for searching the mapping table P2L of the memory 144 for the requested logical addresses WLPN<1:3>.

If the requested logical addresses WLPN<1:3> are not present in the mapping table P2L of the memory 144, the processor 134 may perform an operation of loading required mapping addresses from the non-volatile memory device 150 to the memory 144 and may search for the loaded mapping addresses.

As described above, if the embodiments of the present invention are applied, when a plurality of logical addresses requested by a host are searched for in an address mapping table, logical addresses stored in the address mapping table and the plurality of logical addresses requested by the host can be aligned based on their values. Thereafter, the search range of the address mapping table in which a later logical address of the plurality of logical addresses requested by the host is to be searched for may be narrowed based on a result of the search of a previous logical address of the plurality of logical addresses requested by the host. Accordingly, the plurality of logical addresses requested by the host may be searched for in the address mapping table more effectively and rapidly.

Furthermore, if a previous logical address and later logical address of a plurality of logical addresses requested by a host have a difference equal to or less than a predetermined value, the previous logical address may be searched for using a binary search method, whereas the later logical address may be searched for using a linear search method.

Accordingly, there is an advantage in that a plurality of logical addresses requested by a host may be searched for in an address mapping table more effectively and rapidly.

Although various embodiments have been described for illustrative purposes, it will be apparent to those skilled in the art that various changes and modifications may be made without departing from the spirit and or scope of the invention as defined in the following claims.

What is claimed is:

1. A memory system, comprising:
a memory device including a plurality of storage regions; and
a controller suitable for selecting storage regions indicated by logical addresses from among the plurality of storage regions using a mapping table storing a plurality of pieces of mapping information for mapping a plurality of logical addresses to a plurality of physical addresses corresponding to the plurality of storage regions;
wherein the controller narrows a search range in which a second requested logical address of N logical addresses (N is an integer greater than 2) is to be searched for in the mapping table based on a position in which the mapping information corresponding to a first requested logical address of the N logical addresses has been stored in the mapping table when the N logical addresses are sequentially searched for in the mapping table.

2. The memory system of claim 1, wherein the controller is suitable for:
aligning positions in which the plurality of pieces of mapping information is stored in the mapping table based on the magnitude or sizes of the respective values of the logical addresses corresponding to the plurality of pieces of mapping information, and
aligning a sequence in which the requested N logical addresses are searched for in the mapping table based on magnitude or sizes of values of the respective N logical addresses.

3. The memory system of claim 2, wherein if the plurality of pieces of mapping information is aligned so that the plurality of pieces of mapping information is stored in relatively lower positions in the mapping table when magnitude or sizes of values respectively corresponding to the plurality of pieces of mapping information have relatively smaller values, and the N logical addresses are aligned so that the N logical addresses are searched for in the mapping table relatively earlier when the N logical addresses have relatively smaller values
the controller is suitable for searching only pieces of mapping information stored in positions higher than the position in which the mapping information corresponding to the first requested logical address has been stored in the mapping table for the second requested logical address of the N logical addresses.

4. The memory system of claim 2, wherein if the plurality of pieces of mapping information is aligned so that the plurality of pieces of mapping information is stored in relatively lower positions in the mapping table when magnitude or sizes of values respectively corresponding to the plurality of pieces of mapping information have relatively smaller values and the N logical addresses are aligned so that the N logical addresses are searched for in the mapping table relatively earlier when the N logical addresses have relatively greater values,
the controller is suitable for searching only pieces of mapping information stored in positions lower than the position in which the mapping information corresponding to the first requested logical address has been stored in the mapping table for the second requested logical address of the N logical addresses.

5. The memory system of claim 2, wherein if the plurality of pieces of mapping information is aligned so that the plurality of pieces of mapping information is stored in relatively lower positions in the mapping table when magnitude or sizes of values respectively corresponding to the plurality of pieces of mapping information have relatively greater values and the N logical addresses are aligned so that the N logical addresses are searched for in the mapping table relatively earlier when the N logical addresses have relatively smaller values,
the controller is suitable for searching only pieces of mapping information stored in positions lower than the position in which the mapping information corresponding to the first requested logical address has been stored in the mapping table for the second requested logical address of the N logical addresses.

6. The memory system of claim 2, wherein if the plurality of pieces of mapping information is aligned so that the plurality of pieces of mapping information is stored in relatively lower positions in the mapping table when magnitude or sizes of values respectively corresponding to the plurality of pieces of mapping information have relatively greater values and the N logical addresses are aligned so that the N logical addresses are searched for in the mapping table relatively earlier when the N logical addresses have relatively greater values,
the controller is suitable for searching only pieces of mapping information stored in positions higher than the position in which the mapping information corresponding to the first requested logical address has been stored in the mapping table for the second requested logical address of the N logical addresses.

7. The memory system of claim 2, wherein if the first requested logical address value and second requested logical address value of the N logical addresses have a difference equal to or less than a predetermined value, the controller is suitable for searching the mapping table for the first requested logical address using a binary search method and searching the mapping table for the second requested logical address using a linear search method.

8. The memory system of claim 2, wherein if the first requested logical address value and second requested logical address value of the N logical addresses have a difference equal to or greater than a predetermined value, the controller is suitable for searching the mapping table for the first requested logical address using a binary search method and searching the mapping table for the second requested logical address using a binary search method.

9. The memory system of claim 2, wherein the controller is suitable for:
storing the plurality of pieces of mapping information in the memory device,
selecting pieces of M mapping information (M is an integer greater than N) among the plurality of pieces of mapping information,
loading the pieces of M mapping information onto a temporary storage space,
aligning positions in which the pieces of loaded mapping information are stored in the temporary storage space based on magnitude or sizes of values of logical addresses respectively corresponding to the pieces of loaded mapping information, and
aligning sequence in which the N logical addresses are searched for in the pieces of loaded mapping information based on the magnitude or sizes of the values of the N logical addresses.

10. The memory system of claim 1, wherein:
the memory device comprises a plurality of blocks respectively comprising a plurality of pages, and
the plurality of storage regions respectively corresponds to the plurality of blocks.

11. The memory system of claim 1, wherein:
the memory device comprises a plurality of blocks respectively comprising a plurality of pages, and
the plurality of storage regions respectively corresponds to the plurality of pages.

12. An operating method of a memory system comprising a memory device including a plurality of storage regions, for selecting storage regions indicated by logical addresses from among the plurality of storage regions using a mapping table in which a plurality of pieces of mapping information for mapping a plurality of logical addresses to a plurality of physical addresses corresponding to the plurality of storage regions has been stored, the operating method comprising:
a first search step of searching the mapping table for a first requested logical address of N logical addresses (N is an integer greater than 2); and
a second search step of controlling a search range based on a position in which the mapping information retrieved through the first search step has been stored in the mapping table and searching for a second requested logical address of the N logical addresses.

13. The operating method of claim 12, further comprising:
a position alignment step of aligning positions in which the plurality of pieces of mapping information is stored in the mapping table based on magnitude or sizes of values of the logical addresses respectively corresponding to the plurality of pieces of mapping information prior to the first search step; and
a sequence alignment step of aligning sequence in which the N logical addresses are searched for in the mapping table based on magnitude or sizes of values of the respective N logical addresses prior to the first search step.

14. The operating method of claim 13, wherein the position alignment step comprises:
a first position determination step of aligning the positions in which the plurality of pieces of mapping information is stored in the mapping table so that the plurality of pieces of mapping information is stored in relatively lower positions in the mapping table when magnitude or sizes of values respectively corresponding to the plurality of pieces of mapping information have relatively smaller values; and
a second position determination step of aligning the positions in which the plurality of pieces of mapping information is stored in the mapping table so that the plurality of pieces of mapping information is stored in relatively higher positions in the mapping table when magnitude or sizes of values respectively corresponding to the plurality of pieces of mapping information have relatively smaller values.

15. The operating method of claim 13, wherein the sequence alignment step comprises:
a first sequence determination step of aligning the sequence in which the N logical addresses are searched for in the mapping table so that the N logical addresses are searched for in the mapping table relatively earlier when the values of the respective N logical addresses have relatively smaller values; and
a second sequence determination step of aligning the sequence in which the N logical addresses are searched for in the mapping table so that the N logical addresses are searched for in the mapping table relatively earlier when the values of the respective N logical addresses have relatively greater values.

16. The operating method of claim 15, wherein:
after the first position determination step and the first sequence determination step are performed, the second search step comprises searching only pieces of mapping information stored in positions higher than a position in which the mapping information retrieved through the first search step has been stored in the mapping table for the second requested logical address of the N logical addresses;
after the first position determination step and the first sequence determination step are performed, the second search step comprises searching only pieces of mapping information stored in positions lower than a position in which the mapping information retrieved through the first search step has been stored in the mapping table for the second requested logical address of the N logical addresses;
after the second position determination step and the first sequence determination step are performed, the second search step comprises searching only pieces of mapping information stored in positions lower than a position in which the mapping information retrieved through the first search step has been stored in the mapping table for the second requested logical address of the N logical addresses; and
after the second position determination step and the first sequence determination step are performed, the second search step comprises searching only pieces of mapping information stored in positions higher than a position in which the mapping information retrieved through the first search step has been stored in the mapping table for the second requested logical address of the N logical addresses.

17. The operating method of claim 13, further comprising a step of using a binary search method in the first search step and using a linear search method in the second search step if the first requested logical address value and second requested logical address value of the N logical addresses have a difference with a predetermined value or less.

18. The operating method of claim 13, further comprising a step of using a binary search method in the first search step and using a binary search method in the second search step if the first requested logical address value and second requested logical address value of the N logical addresses have a difference with a predetermined value or more.

19. The operating method of claim 13, wherein the position alignment step comprises:
storing the plurality of pieces of mapping information in the memory device, selecting pieces of M mapping information (M is an integer greater than N) among the plurality of pieces of mapping information, and loading the pieces of M mapping information onto a temporary storage space; and
aligning positions in which the pieces of loaded mapping information are stored in the temporary storage space based on magnitude or sizes of values of logical address respectively corresponding to the pieces of loaded mapping information.

20. The operating method of claim 19, wherein the sequence alignment step comprises aligning sequence in which the N logical addresses are searched for in the pieces of loaded mapping information based on the magnitude or sizes of the values of the respective N logical addresses.
